(19) United States
(12) Patent Application Publication
(10) Pub. No.: US 2026/0187660 A1
(43) Pub. Date: Jul. 2, 2026

(54) GENERATION OF AN INTERACTIVE VISUALIZATION

(71) Applicant: Adobe Inc., San Jose, CA (US)

(72) Inventors: William Brandon George, Pleasant Grove, UT (US); Wenjing Yang, San Jose, CA (US); Travis Sabin, Vineyard, UT (US); Sarah Nicole Borden, South Jordan, UT (US); Paul Cleaver Jones, Lehi, UT (US); Luke R. Penrod, Salem, UT (US); Jonathan Glen Snyder, Draper, UT (US); Jason Christopher McNeal, Lehi, UT (US); Jaden Gilbert Howell, Pleasant Grove, UT (US); Jacob Olson, Provo, UT (US); Erik George Bonn, Lehi, UT (US); Brooke Diane Gemperline, Draper, UT (US); Bradley Joseph Rogers, Highland, UT (US)

(73) Assignee: Adobe Inc., San Jose, CA (US)

(21) Appl. No.: 19/003,356

(22) Filed: Dec. 27, 2024

(51) Int. Cl. G06Q 30/0201; G06F 3/04845

(52) U.S. Cl. CPC G06Q 30/0201; G06F 3/04845

(57) ABSTRACT

Techniques for generation of an interactive visualization are described that support analysis and dynamic display of various aspects of an entity journey. In an example, a processing device receives journey data that describes various interactions, behaviors, and/or properties of entities related to an entity journey. The processing device further receives a construction input to define an initial structure for the interactive visualization. Based on the journey data and the construction input, the processing device generates the interactive visualization for output, such as in a user interface. The interactive visualization includes various nodes that represent attributes of the entity journey that are connected by directed edges. The interactive visualization further includes visual representations of quantitative transitions between adjacent nodes. The processing device is further operable to receive a variety of interactions to update the interactive visualization in real time.

### BACKGROUND

Understanding and analyzing user journeys is desirable across various domains to optimize engagement, improve desired outcomes, and enhance experiences for both users and service provider systems. A user journey, for instance, represents a sequence of interactions and/or steps taken by one or more entities, such as steps taken to navigate a website, utilize an application, or interact with one or more services of a service provider system. However, as user journey data increases in granularity and scope, the difficulty to derive usable insights from the user journey data likewise increases.

Accordingly, conventional techniques to collect, generate, analyze, and/or represent such user journey data are limited. For instance, conventional techniques include static models that are often incompatible with dynamic and multidimensional user journey data, lack an ability to incorporate real-time metrics, and further breakdown for non-linear user journey pathways that include interactions across multiple channels. Consequently, conventional user journey analysis techniques are time-consuming, error-prone, and rely on manual intervention which is inefficient and therefore results in increased power consumption and inefficient use of computational resources.

### SUMMARY

Techniques for generation of an interactive visualization are described that support real-time analysis and visualization of dynamic and multi-modal journey data. In an example, a processing device receives journey data that describes various interactions, behaviors, and/or properties of one or more entities related to an entity journey. The processing device further receives a construction input to define an initial structure of the visualization. Based on the journey data and the construction input, the processing device generates the visualization for output.

The visualization includes nodes that are connected by directed edges. The nodes, for instance, represent various attributes of the entity journey such as dimensions, e.g., categorical attributes, or metrics, e.g., quantitative attributes. The visualization further includes visual representations of quantitative transitions of one or more metrics between adjacent nodes. In various examples, the processing device further receives an input that includes an interaction to apply a transformation to the visualization. The processing device is operable to update the visualization in real time to provide for a variety of functionality not possible using conventional modalities.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the generation of an interactive visualization techniques described herein.

FIG. 2 depicts a system in an example implementation showing operation of a visualization module of FIG. 1 in greater detail.

FIG. 3 depicts an example of generation of an interactive visualization in which an interactive visualization of an entity journey is generated.

FIG. 4 depicts an example of generation of an interactive visualization in which a fallout between nodes is depicted.

FIG. 5 depicts an example of generation of an interactive visualization in which a node is added to the interactive visualization.

FIG. 6 depicts an example of generation of an interactive visualization in which multiple dimensions are combined in an existing node of the interactive visualization.

FIG. 7 depicts an example of generation of an interactive visualization in which information about a particular node is displayed.

FIG. 8 depicts an example of generation of an interactive visualization in which multiple nodes are added to the interactive visualization.

FIG. 9 depicts an example of generation of an interactive visualization in which a dimension is added to an existing node of the interactive visualization to generate a node breakdown.

FIG. 10 depicts an example of generation of an interactive visualization in which a node is added to the interactive visualization.

FIG. 11 depicts an example of generation of an interactive visualization in which a dimension is added to the interactive canvas.

FIG. 12 depicts an example of an interactive visualization of an entity journey.

FIG. 13 depicts an example of generation of an interactive visualization in which a dimension is added to a node to generate a node breakdown.

FIG. 14 depicts an example of generation of an interactive visualization in which a dimension is added to an edge between adjacent nodes.

FIG. 15 depicts an example of generation of an interactive visualization in which an audience segment is generated from a particular node.

FIG. 16 is a flow diagram depicting an algorithm as a step-by-step procedure in an example implementation that is performable by a processing device to generate and transform an interactive visualization of an aggregated user journey.

FIG. 17 is a flow diagram depicting an algorithm as a step-by-step procedure in an example implementation that is performable by a processing device to generate a dataset query to obtain information for inclusion in an interactive visualization.

FIG. 18 illustrates an example system including various components of an example device that can be implemented as any type of computing device as described and/or utilized with reference to FIGS. 1-17 to implement embodiments of the techniques described herein.

### DETAILED DESCRIPTION

### Overview

Comprehensive analysis of user journey data is paramount to obtain a holistic understanding of how entities interact with a variety of services, experiences, and/or products. For instance, user journey data includes information about how various entities interact with one or more systems, products, or services. In an example, user journey data includes data touchpoints for a variety of cross-channel interactions between a multitude of entities and diverse engagement points. Accordingly, such user journey data often includes petabytes to exabytes of data to represent billions or trillions of data touchpoints.

Consequently, conventional user journey data analysis techniques face significant limitations. For instance, conventional techniques include static models that rely on a limited number of predefined stages with limited data capacity and thus are incompatible with dynamic multi-channel user journey data with cross-channel data touchpoints. Further, many conventional techniques are forced to reconcile storage constraints through approximation techniques, implementation of capacity limits, and/or “destructive” analysis techniques that fundamentally and irreversibly change the underlying user journey data, such as overwriting data, truncation of data, and/or consolidating data. Thus, conventional techniques experience limited insights as well as limitations when revisiting data.

Further, modalities to visualize such analyses are constrained by the limitations of conventional analysis techniques. For instance, such modalities that are reliant on conventional static models are unable to represent a nonlinear and dynamic nature of a user journey. Additionally, visualization modalities that implement destructive analysis techniques obfuscate granular insights and further are unable to provide subsequent insights. Accordingly, conventional visualization techniques provide diminished capacity for large-scale, dynamic, and cross-channel user journeys and thus offer limited functionality to depict a variety of insights.

Techniques for generation of an interactive visualization are described that overcome conventional limitations. As explained in more detail in the following example, the techniques described herein present a holistic visualization of a user journey, such as to depict quantitative transitions between a variety of attributes of journey data. The techniques described herein further support user interaction with the visualization to provide real time updates and support a variety of functionality that is not possible using conventional techniques.

In an example to do so, a processing device receives an input that includes a variety of journey data that describes one or more interactions, behaviors, and/or properties of one or more entities (e.g., users, devices, customers, systems, etc.) related to an entity journey, e.g., a user journey. The journey data, for instance, includes data touchpoints associated with interactions between the entities and engagement points of various products, services, systems, applications, or environments.

The processing device then generates a journey dataset that represents an aggregated entity journey for the entities based on the journey data. The journey dataset, for instance, is a structured representation of various attributes of the journey data and includes dimensions that represent categorical attributes of the entity journey as well as metrics that represent quantitative attributes of the entity journey. A variety of categorical attributes are considered, such as one or more touchpoints, entity characteristics such as demographic/behavioral data, time-based data, device characteristic data, processing behavior, etc. A variety of metrics are also considered, such as a number of users, engagement metrics, conversion metrics, and so forth.

In one example, the processing device leverages a query engine, e.g., an optimized columnar database query engine, to generate, maintain, analyze, and/or retrieve information from the journey dataset. The query engine, for instance, is sharded and distributes processing and/or data management operations across two or more processing/storage components, e.g., “shards.” The query engine is further configured to implement non-destructive data analysis techniques. In this way, the techniques described herein conserve computational resources relative to conventional approaches and provide real-time processing operability while maintaining integrity of the underlying data.

The processing device further receives a construction input that defines a structure of the visualization, such as an initial configuration of nodes and edges. By way of example, the construction input includes a user input to position the nodes on a digital canvas displayed in a user interface of the processing device. The construction input further includes a user input to connect the nodes to one another with various edges. In at least one example, the visualization is configured with a non-linear directed acyclic structure, with each edge having a directionality and the visualization includes one or more branching edges and/or converging edges.

The nodes, for instance, are visual representations of one or more attributes of the entity journey. In an example, a particular node represents one or more dimensions, e.g., categorical attributes, and/or one or more metrics, e.g., quantitative attributes, based on the journey dataset. The edges represent a transition, interaction, and/or flow between the nodes. For example, an edge between two adjacent nodes signifies a progression of a user from a first touchpoint to a second touchpoint. In various examples, a directionality of an edge indicates a flow of information, such as from a particular node to a subsequent node.

The nodes and/or edges further include a variety of visual indicia, and in various examples the visualization depicts a quantitative transition of a primary metric between adjacent nodes. By way of example, a primary metric represents a number of users and nodes in a visualization represent different touchpoint of an entity journey. A quantitative transition indicates a number of users that progressed from a first node that represents a first touchpoint to an adjacent second node that represents a second touchpoint.

In an example to generate various information to be depicted by the visualization (e.g., one or more quantitative transitions) the processing device leverages the query engine to analyze the journey dataset. For instance, the processing device generates a dataset query for processing by the query engine based on a structure of the visualization. The query engine distributes processing operations across various shards to generate a response to the dataset query, which is then populated into the visualization. In this way, the query engine obtains information from the journey dataset in real time without alteration to the underlying data and thus preserves an ability of the processing device to make subsequent changes to the visualization.

Accordingly, these techniques are further usable to support a variety of interactions with the visualization, such as to apply various transformations to the visualization and update information included in the visualization in real time. For instance, the processing device receives an interaction to apply a transformation to the interactive visualization to generate an updated visualization. In various examples, the transformation includes adjusting a dimension.

Adjusting a dimension, for instance, includes one or more of adding the dimension to a node or edge, removing the dimension from the visualization, combining the dimension with one or more additional dimensions, etc. To update various visual indicia in the updated visualization, the processing device generates one or more additional dataset queries based on a structure of the updated visualization and the transformation, e.g., the adjusted dimension. The processing device leverages the query engine to process the additional dataset queries and populates results of the processing to corresponding portions of the updated visualization in real time.

In this way, the techniques described herein support dynamic interaction with the visualization and generation of real time updates that provide a variety of insights related to an entity journey. The techniques described herein further leverage non-destructive analysis techniques that are suitable for dynamic cross-channel journey data, which is not possible using conventional techniques that rely on destructive analysis techniques, approximation techniques, and/or static models. Further discussion of these and other examples and advantages are included in the following sections and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Term Examples

As used herein, the term “entity journey” refers to a sequence of interactions and/or steps taken by one or more entities (e.g., users in a user journey) during engagement with one or more products, services, systems, etc. In various examples, the entity journey includes steps taken to navigate a website, utilize an application, or interact with one or more services provided by a service provider system.

As used herein, the term “journey data” refers to data that describes one or more interactions, behaviors, and/or properties of one or more entities (e.g., users, devices, customers, systems, etc.) related to an entity journey. In various examples, the journey data includes data touchpoints associated with interactions between various entities and engagement points of various products, services, systems, and/or environments. In various embodiments the journey data includes one or more digital touchpoints, representations of one or more non-digital touchpoints and/or one or more cross-channel interactions, such as transitions between digital and non-digital touchpoints.

As used herein, the term “journey dataset” refers to a structured representation that represents an aggregated entity journey for one or more entities. In various examples, the journey dataset is constructed to include one or more dimensions that represent categorical attributes of the journey data as well as one or more metrics that represent one or more quantitative attributes of the journey data. In at least one example, the journey dataset represents attributes of the journey data using a binary bit shifted format.

As used herein, the term “dimension” refers to a categorical attribute of the journey dataset. In various examples, a dimension includes one or more of a touchpoint, entity information, demographic information, device properties of entities, channel information, and so forth.

As used herein, the term “metric” refers to a quantitative attribute of the journey dataset. In various examples, a metric includes numerical properties and/or measures of various touchpoints related to an entity journey. For example, a metric includes one or more entity metrics, conversion metrics, interaction metrics, and so forth. In some implementations, the metrics quantify one or more aspects of a particular dimension. In some examples, a primary metric represents a metric that is a subject of a quantitative transition across nodes of the interactive visualization.

As used herein, the term “visualization” refers to an interactive representation of an aggregated entity journey for one or more entities. In various examples, the visualization includes one or more nodes connected by one or more edges. In one or more embodiments, the visualization further includes a variety of visual indicia such as a representation of a quantitative transition between adjacent nodes. In at least one example, the visualization has a nonlinear and directed acyclic structure.

As used herein, the term “node” refers to a visual representation of one or more attributes of an entity journey included in the visualization. The node, for instance, represents one or more dimensions and/or metrics included in the journey dataset. Each node is configurable to include a variety of visual indicia.

As used herein, the term “edge” refers to a visual representation of a transition, interaction, and/or flow between nodes of the visualization. In various examples, the edges include visual representations of information related to an entity journey. In some embodiments, the edges include one or more branches/divergences and/or one or more convergences.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

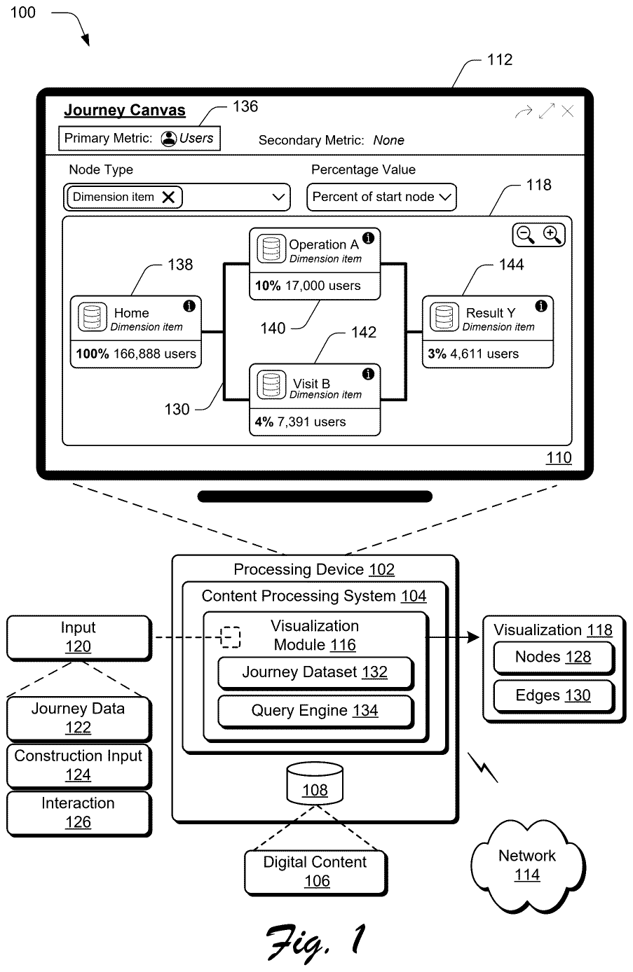

FIG. 1 is an illustration of a digital medium environment 100 in an example implementation that is operable to employ the generation of an interactive visualization techniques described herein. The illustrated environment 100 includes a processing device 102, which is configurable in a variety of ways.

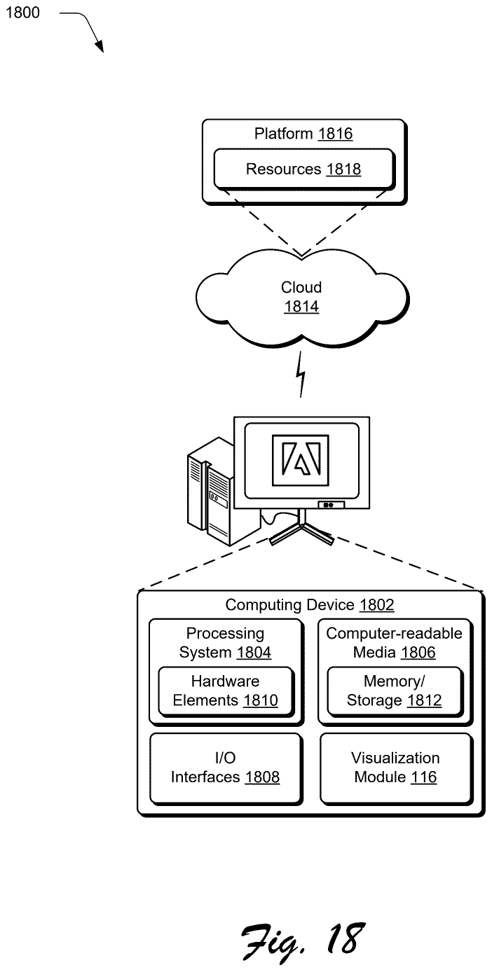

The processing device 102, for instance, is configurable as a variety of computing devices such as one or more of a desktop computer, a laptop computer, a mobile device (e.g., assuming a handheld configuration such as a tablet or mobile phone), and so forth. Thus, the processing device 102 ranges from full resource devices with substantial memory components and processor resources (e.g., personal computers, game consoles) to a low-resource device with limited memory and/or processing resources (e.g., mobile devices). Additionally, although a single processing device 102 is shown, the processing device 102 is also representative of a plurality of different devices, such as multiple servers utilized by a business to perform operations “over the cloud” as described in FIG. 18.

The processing device 102 is illustrated as including a content processing system 104. The content processing system 104 is implemented at least partially in hardware of the processing device 102 to process digital content 106, which is illustrated as maintained in storage 108 of the processing device 102. Such processing includes receiving the digital content 106, creation of the digital content 106, modification/transformation of the digital content 106, and rendering of the digital content 106 in a user interface 110 for output, e.g., by a display device 112. In various examples, the digital content 106 is representative of a variety of data related to an entity journey, such as journey data as further described below. Although illustrated as implemented locally at the processing device 102, functionality of the content processing system 104 is also configurable in whole or in part via functionality available via the network 114, such as part of distributed computing, parallel processing, part of a web service or “in the cloud.”

An example of functionality incorporated by the content processing system 104 to process the digital content 106 is illustrated as a visualization module 116. The visualization module 116, for instance, is configured to generate a visualization 118, such as an interactive visualization of an aggregated entity journey for one or more entities (e.g., users, devices, customers, systems, etc.) based on an input 120 that includes journey data 122, a construction input 124, and/or an interaction 126. As described in more detail below, the visualization 118 includes a plurality of nodes 128 that are connected to one another by one or more edges 130.

Generally, the journey data 122 includes data that describes one or more interactions, behaviors, and/or properties of one or more entities (e.g., users, devices, customers, systems, etc.) related to an entity journey. For example, the journey data 122 includes data touchpoints associated with interactions between one or more entities and one or more engagement points of various products, services, systems, or environments. In various embodiments the journey data 122 includes one or more digital touchpoints (e.g., website visits, click, application interactions, social media engagements, online purchases and/or downloads, etc.), representations of one or more non-digital touchpoints (e.g., “in-store” behaviors, customer service interactions, physical actions, etc.) and/or one or more cross-channel interactions, such as transitions between digital and non-digital touchpoints.

Additionally or alternatively, the journey data 122 represents one or more entity actions, temporal properties (date ranges, timestamps, action lengths, etc.), device/system properties, and/or behavioral metrics associate with the entities. In some implementations, the journey data 122 includes a variety of demographic information about the one or more entities. In various embodiments, the journey data 122 is dynamic, such that the journey data 122 is continually updated.

The visualization module 116 processes the journey data 122 to generate a journey dataset 132 that represents an aggregated entity journey for the one or more entities. The journey dataset 132 is constructed to include one or more dimensions that represent categorical attributes of the journey data 122 as well as one or more metrics that represent one or more quantitative attributes of the journey data 122. In at least one example, the visualization module 116 leverages a query engine 134, e.g., an optimized columnar database query engine, to generate, maintain, and/or analyze the journey data 122 and/or the journey dataset 132. In various embodiments, the query engine 134 is sharded, e.g., the query engine 134 distributes processing and/or data across two or more processing/storage components such as via communication via the network 114 to conserve computational resources and provide real-time processing operability.

Based on the journey dataset 132 and the construction input 124, the visualization module 116 generates the visualization 118. For instance, the construction input 124 defines a structure of the visualization 118, such as an initial configuration of nodes 128, edges 130, and/or various parameters to construct the visualization 118. In an example, the construction input 124 includes a user input to position various nodes 128 and/or edges 130 on a digital canvas. This is by way of example and not limitation, and in various examples the construction input 124 includes an automated input, such as to define an initial structure for the visualization 118 automatically and without user intervention.

The nodes 128, for instance, are visual representations of one or more attributes of the journey dataset 132. For example, a particular node 128 represents a dimension and/or a metric included in the journey dataset 132. The edges 130 thus represent a transition, interaction, and/or flow between the nodes 128. In various examples, the visualization 118 depicts a quantitative transition between adjacent nodes 128, such as with respect to one or more metrics, e.g., a primary metric 136. In various examples, a value for the primary metric 136 is displayed by each of the nodes 128 in the visualization 118.

In the illustrated example, a first node 138 is connected to a second node 140 and a third node 142 by branching edges 130. The second node 140 and the third node 142 are further connected by converging edges 130 to a fourth node 144. In this example, the visualization 118 is representative of a user journey for a plurality of users, such as various steps involved in progressing from a homepage of a particular website to a particular result. The primary metric 136 in this example is a number of users, and thus each node 128 of the visualization 118 depicts a quantitative transition of a number of users between adjacent nodes 128.

For instance, the first node 138 represents a “home” touchpoint and indicates that 166,668 users started a user journey at the home touchpoint, e.g., the homepage of the particular website, and thus qualify for the first node 138. The second node 140 depicts a number of users that progressed from the home touchpoint to perform a particular operation, e.g., “Operation A”. For instance, 10% of the initial number of users (e.g., 17,000 users) performed Operation A after visiting the homepage touchpoint and thus qualify for the second node 140.

The third node 142 depicts a number of users that progressed from the homepage touchpoint to a different touchpoint, e.g., “Visit B”. For instance, 4% of the initial number of users (e.g., 7,931 users) visited a particular webpage “B” after visiting the homepage represented by the first node 138. The fourth node 144 represents a number of users that achieved a particular result, e.g., “Result Y”, after starting at the homepage and either performing Operation A or visiting a webpage B. For instance, 3% of the initial number of users (e.g., 4,611 users) arrived at the Result Y after starting at the homepage and either performing Operation A or visiting a webpage B. In this way, the techniques described herein provide a customizable modality to efficiently visualize various aspects of a user journey and relationships between different aspects of the journey dataset 132.

As further described in more detail below, in some examples the input 120 further includes an interaction 126, which is representative of an input to change one or more properties of the visualization 118. A variety of interactions 126 are considered, such as to adjust one or more dimensions of the visualization 118, add/remove/reposition one or more of the nodes 128 and/or edges 130, generate various supplemental analyses, and/or perform a variety of functionality. The visualization module 116 is configured to update the visualization 118 in real time based on the interaction 126, which is not possible using conventional techniques that utilize static models and/or destructive data analysis techniques. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Generation of an Interactive Visualization

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made to FIGS. 1-17.

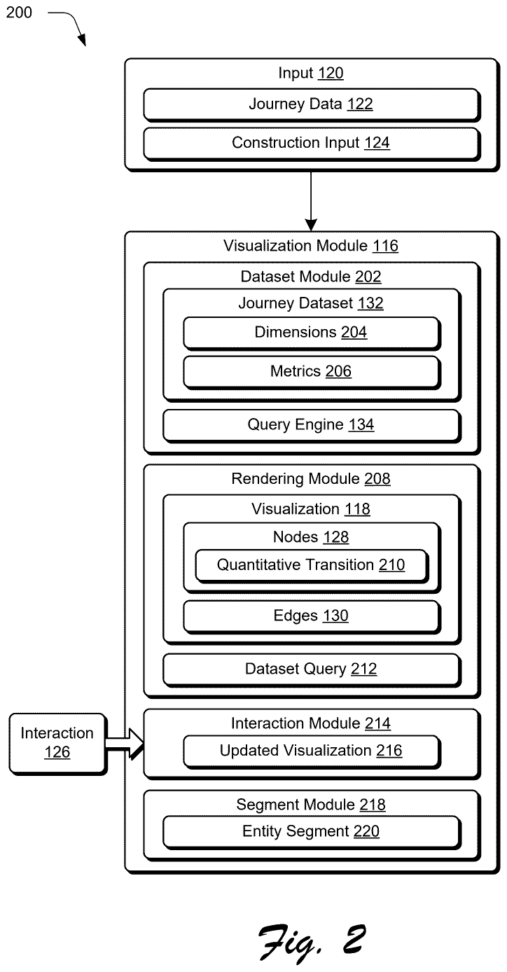

FIG. 2 depicts a system 200 in an example implementation showing operation of a visualization module 116 of FIG. 1 in greater detail. Generally, the visualization module 116 is operable to generate and update a visualization 118 that depicts various aspects and relationships of an aggregated entity journey. An entity journey (e.g., a user journey), for instance, represents a sequence of interactions and/or steps taken by one or more entities through one or more defined processes, systems, or workflows. As described in more detail below, the visualization module 116 is operable to leverage the visualization 118 to perform a variety of functionality not possible using conventional techniques.

In an example, the visualization module 116 receives an input 120 that includes journey data 122 as well as a construction input 124. As described above, the journey data 122 describes one or more interactions, behaviors, and/or properties of one or more entities (e.g., users, devices, customers, systems, etc.) related to an entity journey. For example, the journey data 122 includes data touchpoints associated with interactions between one or more entities and one or more engagement points of various products, services, systems, applications, or environments.

In various embodiments the journey data 122 includes one or more digital touchpoints (e.g., website visits, clicks, application interactions, social media engagements, online purchases and/or downloads, etc.), representations of one or more non-digital touchpoints (e.g., “in-store” behaviors, customer service interactions, physical actions, etc.) and/or one or more cross-channel interactions, such as transitions between digital and non-digital touchpoints.

Additionally or alternatively, the journey data 122 represents one or more entity actions, temporal properties (e.g., date ranges, timestamps, action lengths, etc.), device/system properties (e.g., computational resource usage at various touchpoints, device type, operating system, etc.), and/or behavioral metrics associate with the entities. In some implementations, the journey data 122 includes a variety of demographic information about the one or more entities. In various embodiments, the journey data 122 is dynamic and/or multimodal, such that the journey data 122 is continually updated from a variety of sources. Accordingly, the visualization module 116 is operable to receive the journey data 122 from a variety of sources and/or from a variety of channels, e.g., web channels, mobile channels, in-store channels, etc.

The visualization module 116 includes a dataset module 202 that is configured to generate a journey dataset 132 based on the journey data 122. The journey dataset 132, for instance, represents an aggregated entity journey for various entities. The dataset module 202 constructs the journey dataset 132 to include various attributes, such as one or more dimensions 204 that represent categorical attributes of the journey data 122 as well as one or more metrics 206 that represent one or more quantitative attributes of the journey data 122.

The dimensions 204, for instance, are representative of categorical elements included in the journey dataset 132 such as one or more of a touchpoint, entity identification, username, page name, action name and/or properties (click, search, add to cart, cancel, etc.), demographic information (age, gender, location, etc.), user type (e.g., new user, returning user, etc.) membership level (e.g., organizational classifier, status level, etc.), device properties (e.g., processing capabilities, mobile vs desktop, computational resource usage, etc.) channel information (website, mobile application, email, in-store, social media, etc.), and so forth.

The metrics 206 represent quantitative attributes of the journey dataset 132, such as numerical properties and/or measures of various touchpoints of an entity journey. By way of example and not limitation, the metrics 206 include one or more entity metrics (e.g., a number/percentage/ratio of entities), engagement metrics (e.g., page views, clicks, time spent at a particular touchpoint, session duration, scroll speed, etc.) conversion metrics (e.g., ratio/percentage/number of users who complete a particular action), interaction metrics (e.g., clicks per session, time to conversion, action frequency, error rate, etc.), and so forth. In one or more examples, the metrics 206 quantify one or more aspects of a particular dimension 204. In various embodiments, the journey dataset 132 further includes segments that group entities, e.g., users, based on common attributes, such as shared dimensions 204 and/or metrics 206.

In at least one example, the visualization module 116 leverages a query engine 134, e.g., an optimized columnar database query engine, to generate, maintain, analyze, and/or retrieve information from the journey data 122 and/or the journey dataset 132. The query engine 134, for instance, is configured to implement non-destructive and/or retroactive data analysis techniques, such as to analyze the data included in the journey dataset 132 without alteration.

In an example, the dataset module 202 implements the query engine 134 to index the journey data 122 into a columnar format. Accordingly, as further described in more detail below, the visualization module 116 is operable to query the journey dataset 132 via read operations to the columns using the query engine 134, which reduces computational resource consumption and increases processing efficiency and speed. In at least one example, the journey dataset 132 maintains the dimensions 204 and/or the metrics 206 in a binary bit shifted format, such as to further increase computational efficiency during generation of responses to queries to the journey dataset 132.

In various embodiments, the query engine 134 is sharded, e.g., the query engine 134 distributes processing and/or data across two or more processing/storage components (e.g., “shards”) such as via communication via the network 114 to conserve computational resources and provide real-time processing operability without causing irreversible changes to the underlying data. For instance, the dataset module 202 identifies two or more shards to perform parallel processing operations, e.g., to independently execute portions of a query to the journey dataset 132. In various examples, the dataset module 202 further includes a central coordinator to aggregate results from the respective shards to provide a comprehensive response to the query.

The dataset module 202 is further operable to allocate processing tasks to shards based on a variety of considerations such as processing power of the respective shards, properties of the journey dataset 132, and/or properties of input queries. By way of example and not limitation, the dataset module 202 allocates a first processing task related to a particular dimension 204 (e.g., a particular user segment and/or timespan) to a first shard based on a property of the first shard, e.g., a detected processing power of the first shard, and/or a property of the particular dimension 204, e.g., a complexity of the particular dimension 204. The dataset module 202 allocates a second processing task related to a different dimension 204 (e.g., a different user segment, timespan, etc.) to a second shard based on a detection that the second shard is capable of performing the second processing task more efficiently relative to the first shard. In this way, the dataset module 202 is operable to maximize computational efficiency based on properties of either or both the various shards and/or the journey dataset 132.

In various examples, the dataset module 202 further generates one or more integrated operations, e.g., integrated data processing operations, to be incorporated into one or more dimensions 204 and/or metrics 206 of the journey dataset 132. For instance, the dataset module 202 generates the journey dataset 132 such that the dimensions 204 and/or the metrics 206 have one or more integrated operations such as string manipulation, entity deduplication, and/or value filtering “baked in” such that the integrated operations are performed automatically and without user intervention.

For example, the dataset module 202 embeds a string manipulation operation such as to modify and/or analyze one or more strings included in a particular dimension and/or attribute. An entity deduplication operation, for instance, reduces and/or eliminates redundant data entries within the journey dataset 132, such as across one or more dimensions 204 and/or metrics 206. A value filtering operation, for instance, is implemented to refine the journey dataset 132 such as to focus on data entries that fulfill particular criteria, e.g., are within a particular range. In this way, the dataset module 202 is operable to directly associate a variety of operations with the one or more dimensions 204 and/or metrics 206 to format and/or refine the journey dataset 132 to support efficient information retrieval for a variety of queries.

The visualization module 116 further includes a rendering module 208 that is operable to generate the visualization 118 based on the journey dataset 132 as well as the construction input 124. As described above, the construction input 124 defines a structure of the visualization 118, such as an initial configuration of nodes 128, edges 130, and/or parameters to construct the visualization 118. For instance, the construction input 124 includes a user input to position various nodes 128 on a digital canvas displayed in a user interface 110 and connect the nodes 128 to one another using various edges 13o. In an additional or alternative example, the construction input 124 is generated automatically and without user intervention, such as a suggested configuration of the visualization 118 to view particular insights, based on previous visualizations 118, based on an AI-assisted configuration, etc.

The nodes 128 of the visualization 118 are visual representations of one or more attributes of an entity journey. For instance, a particular node 128 represents one or more dimensions 204 and/or one or more metrics 206 included in the journey dataset 132. Additionally or alternatively, a particular node 128 represents one or more prebuilt segments (e.g., user segments), date ranges, and/or filters. In various examples, the nodes 128 further include an integrated data processing operation, such as one or more of a string manipulation operation, a value filtering operation, or an entity deduplication operation as described in more detail above.

The edges 130 represent a transition, interaction, and/or flow between the plurality of nodes 128. For example, an edge 130 between two adjacent nodes 128 signifies a progression of an entity from a first touchpoint to a second touchpoint. In various examples, the edges have a directionality that indicates a flow of information, such as from a particular node to a subsequent node.

The nodes 128, for instance, include one or more incoming edges 130 and/or one or more outgoing edges 130. In various embodiments, the edges 130 include one or more branches (e.g., forks) that connect one or more nodes 128 to a greater number of adjacent nodes 128 and/or one or more convergences that connect multiple nodes 128 to a lesser number of nodes 128. In at least one example, the visualization 118 is configured with a directed acyclic structure such that the nodes 128 are connected by directed edges 130, each edge 130 has a specific direction, and the visualization 118 does not include a cycle.

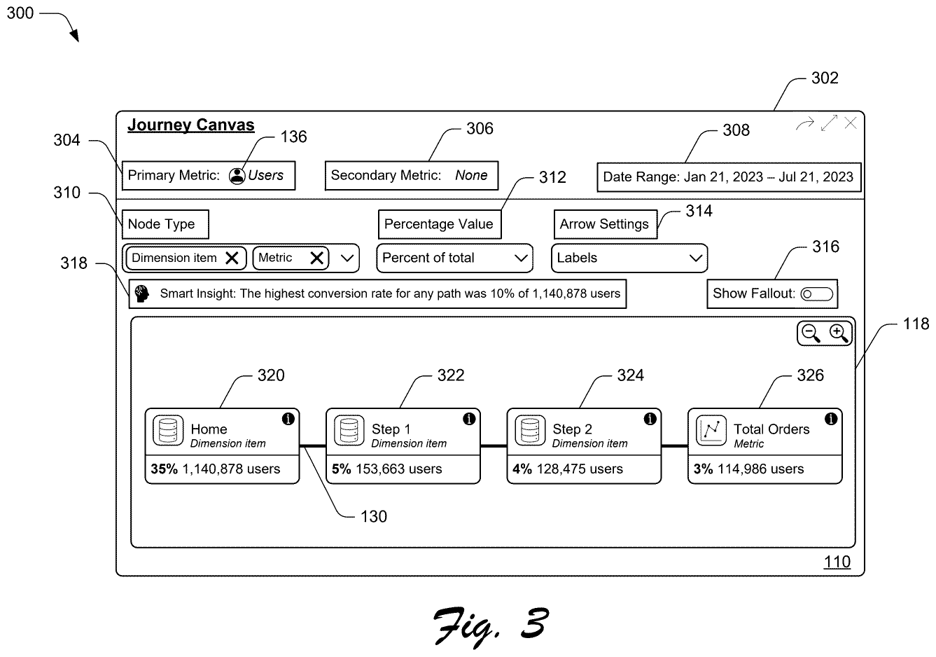

As depicted in the following examples in FIGS. 3-15, the nodes 128 and/or the edges 130 include a variety of visual indicia. A particular node 128, for instance, includes identification information, such as a node identifier, a node type, and/or a node label. In some examples, the particular node 128 is color coded based on a type of node, e.g., whether the node represents a dimension 204 or a metric 206. In various examples, the edges 130 further include visual indicia, such as one or more labels, changes between adjacent nodes, values relevant to the entity journey, etc.

In various examples, the visualization 118 depicts a quantitative transition 210 between adjacent nodes 128, such as with respect to one or more metrics, e.g., a primary metric 136. By way of example, each node 128 in a particular visualization 118 represents a touchpoint on an entity journey and the primary metric 136 represents a number of users. Accordingly, each node 128 includes an indication of a quantitative transition 210 between the node 128 an adjacent node, such as a change in the primary metric 136 between a particular node and a subsequent node. For instance, the subsequent node includes an indication of a quantity (e.g., number, percentage, ratio, etc.) of a number of users that progressed from the particular node to the subsequent node.

In various examples, as part of generation of the visualization 118, the rendering module 208 is operable to generate one or more dataset queries 212. For instance, the rendering module 208 generates a dataset query 212 based on the structure of the visualization 118. The dataset query 212, for instance, includes one or more structured requests for access to and/or analysis of the journey dataset 132, such as by the query engine 134. The dataset module 202 is operable to process the dataset query 212 in real time, such as to determine the quantitative transition 210 and/or additional information to be depicted by the visualization 118. Accordingly, the dataset query 212 is configurable to include a variety of information such as one or more metrics 206 (e.g., the primary metric 136), a representation of a structure of the visualization 118, and/or one or more dimensions 204.

In an example to generate one or more dataset queries 212, the rendering module 208 generates a group of paths based on the visualization 118. In at least one example, the group of paths includes one or more paths for each node 128 and/or each edge 130 of the visualization 118. A path, for instance, is representative of a potential action and/or sequence of actions taken by an entity as part of an entity journey.

To build the group of paths, the rendering module 208 identifies one or more start nodes, such as via detection of nodes 128 that do not include incoming edges 130. The rendering module 208 is operable to generate a single-node path for each of the start nodes. The rendering module 208 then traverses outgoing edges 130 from each start node to create multi-node paths, e.g., Node 1<edge>Node 2. The rendering module 208 is configured to repeat this process for each subsequent node in the visualization 118. The rendering module 208 further recurses each terminal node in the visualization 118, e.g., each node 128 with one or more incoming edges 130 and without outgoing edges 130, such as by backpropagating one or more operations in a direction of the incoming edges 130.

Once the rendering module 208 has generated the group of paths for the visualization 118, the rendering module 208 is further operable to “dedupe” the group of paths, e.g., to perform one or more data deduplication operations on the group of paths. For instance, the rendering module 208 identifies and eliminates redundant paths included in the group of paths, such as to conserve computational resources during processing of the one or more dataset queries 212.

The rendering module 208 is further operable to create sequential segment representations for each deduped path in the group of paths. A segment representation, for instance, includes one or more entities included in the journey dataset 132 that qualify for a particular path. An entity qualifies for a particular path if the entity has traversed the nodes 128 and edges 130 of the particular path in an order prescribed by the path. Accordingly, the rendering module 208 is operable to identify entities included in the journey dataset 132 that qualify for a particular path of the group of paths to generate the segment representations.

The rendering module 208 is then operable to generate a dataset query 212 for each of the segment representations. The dataset queries 212, for instance, are with respect to a particular metric 206, e.g., the primary metric 136. For example, a particular dataset query 212 includes a particular segment representation, the primary metric 136, and a request for information from the journey dataset 132. By way of example, the primary metric 136 represents a number of users, and thus the one or more dataset queries 212 are configured to determine how many users are within each segment representation.

In one or more examples, the rendering module 208 communicates a particular dataset query 212 to the dataset module 202 to generate a response to the particular dataset query 212. For instance, the dataset module 202 leverages the sharded query engine 134 to process the particular dataset query 212 to generate the response in real time. The rendering module 208 is then configured to apply a result of the dataset queries 212 to each corresponding node/edge, such as to display a variety of visual indicia in the visualization 118.

Accordingly, the techniques described herein are operable to integrate information to the visualization 118 through real time non-destructive data analysis. For instance, by querying the journey dataset 132 without alteration to the underlying data, the techniques described herein preserve an ability of the visualization module 116 to make subsequent changes to the visualization 118. This overcomes the limitations of conventional techniques that apply destructive analysis such as through application of transformations directly to journey data itself.

In various examples, the input 120 further includes an interaction 126. The interaction 126, for instance, represents an input to change one or more properties of the visualization 118 such as to apply one or more transformations to the visualization 118. A variety of interactions 126 are considered, such as to adjust one or more metrics 206 and/or dimensions 204, add/remove/reposition one or more of the nodes 128 and/or edges 130, generate various supplemental analyses, and/or perform a variety of functionality. Examples of interactions 126 are shown in the following examples in FIG. 3-FIG. 15.

The visualization module 116 includes an interaction module 214 that is operable to modify the visualization 118 to generate an updated visualization 216 based on the interaction 126. In one or more examples, the visualization 118 implements one or more retroactive transforms (e.g., nondestructive data processing operations) to update visual indicia included in the nodes 128 and/or edges 130. In this way, the techniques described herein preserve underlying data of the journey dataset 132 to support subsequent modification.

In an example, the interaction 126 includes an operation to modify a structure of the visualization 118. The interaction module 214 is configured to leverage the rendering module 208 and/or the dataset module 202 to update one or more visual indicia included in the nodes 128 and or the edges 130 based on the modified structure.

For instance, the interaction module 214 leverages the rendering module 208 to generate one or more additional dataset queries 212 based on the interaction 126 in accordance with the techniques described above. The interaction module 214 leverages the dataset module 202 to obtain responses to the additional dataset queries 212. The interaction module 214 then leverages the rendering module 208 to update the visualization 118 to incorporate the responses to corresponding locations within the updated visualization 216.

Consider an example in which the interaction 126 includes an input to apply a transformation to the visualization 118 by adjusting a dimension 204 of the visualization 118. For instance, the interaction 126 includes an input to add a node 128 that represents a particular dimension 204 to the visualization 118. This is by way of example and not limitation, and in alternative or additional examples an adjustment to a dimension 204 includes one or more of an input to remove a node 128 that represents a dimension 204 from the visualization 118, to add a dimension 204 to an existing node 128, to combine one or more dimensions 204, and/or to add a dimension 204 to an existing edge 130.

In this example, the added node is inserted between a first node and a second node that depict a quantitative transition 210 of a primary metric 136. The interaction module 214 generates additional dataset queries 212 based on the added node in accordance with the techniques described above. The interaction module 214 further generates the updated visualization 216 to include updated visual indicia based on responses to the additional dataset queries 212. For instance, the updated visualization 216 includes a first quantitative transition 210 between the first node and the added node and a second quantitative transition 210 between the added node and the second node. In this way, the techniques described herein are usable to dynamically update the visualization 118 in real time to provide for a variety of functionality.

In some examples, the visualization module 116 further includes a segment module 218. The segment module 218, for instance, is operable to generate an entity segment 220 that includes representations of entities that share a common characteristic and/or attribute with respect to an entity journey. For instance, the segment module 218 is configured to generate an entity segment 220 that includes each entity that qualifies (e.g., is represented by) a particular node 128 and/or a particular edge 130. The segment module 218 is further operable to generate an entity segment 220 based on detected fallout between adjacent nodes, such as an entity segment 220 that includes entities that did not progress from a first node to a second node.

In various examples, the entity segment 220 includes one or more of identification information about one or more entities, demographic information about the one or more entities, contact information, behavioral information, etc. In some implementations, the segment module 218 is further operable to perform one or more actions with respect to the entity segment 220. By way of example, the segment module 218 causes digital content 106 to be communicated to the entity segment 220, such as to deliver a targeted advertisement to various users.

In an additional or alternative example, the visualization 118 represents a pathway taken by various entities that are part of a shared system, e.g., various processing devices within a distributed computing system. For instance, nodes 128 of the visualization 118 in this example represent various processing operations and/or steps. The segment module 218 generates an entity segment 220 to include “fallout” entities that did not progress from a first node to a second node, such as due to a computational constraint and/or a processing ability limitation of the fallout entities.

Accordingly, the entity segment 220 includes entities, e.g., representations of processing devices, that lack sufficient processing resources to advance from the first node to the second node. The segment module 218 is operable to perform one or more actions with respect to the entity segment 220, such as to allocate computational and/or processing resources to the entities within the entity segment 220. Accordingly, the techniques described herein are usable in a variety of contexts to perform and/or support a variety of functionality.

FIG. 3 depicts an example 300 of generation of an interactive visualization in which an interactive visualization of an entity journey is generated. In this example, a user interface 110 depicts an interactive canvas 302 that includes the visualization 118, which is generated in accordance with the techniques described herein. The user interface 110 further includes a primary metric indicator 304, a secondary metric indicator 306, and a date range indicator 308. The primary metric indicator 304, for instance, indicates that a primary metric 136 in this example is a number of users. Accordingly, the nodes 128 of the visualization 118 include representations of the primary metric 136.

The secondary metric indicator 306 indicates that no secondary metric is displayed by the visualization 118. This is by way of example and not limitation, and in various examples the visualization 118 includes visual indicia that depict quantitative transitions between two or more metrics 206 between adjacent nodes. In this example, the date range indicator 308 indicates a temporal constraint for the information provided by the visualization 118, e.g., Jan. 21, 2023 to Jul. 21, 2023. The primary metric indicator 304, the secondary metric indicator 306, and the date range indicator 308 are each selectable to provide variable inputs.

The interactive canvas 302 further includes a node type indicator 310, a percentage value setting 312, an arrow settings indicator 314, a fallout visualization selector 316, and a smart insight 318. The node type indicator 310, for instance, specifies types of nodes 128 that are present in the visualization 118. In the illustrated example, for instance, the nodes 128 include dimension items as well as metric items.

The percentage value setting 312 includes a dropdown menu to control display settings for each node 128. In the illustrated example, the percentage value setting 312 indicates that each node 128 includes a representation of the primary metric 136 that is a “percent of total,” such as a percent of users that progressed along the entity journey. In alternative or additional examples, the percentage value setting 312 is selectable such that each node 128 includes a representation of the primary metric 136 that is percentage of a start node and/or a percentage of a previous node.

The arrow settings indicator 314 indicates a display setting for the edges 130. In the illustrated example, the arrow settings indicator 314 indicates that the edges 130 are able to include “labels.” Accordingly, although not depicted in the illustrated example the edges 130 are configurable to include labels to describe properties of transitions between adjacent nodes. In alternative or additional examples, the arrow settings indicator 314 is selectable to provide for a variety of edges 130 display settings.

The fallout visualization selector 316 in this example is a selectable button that determines whether or not to include a representation of “fallout” between adjacent nodes. Fallout, for instance, represents a number of users that did not transition from a particular node to an adjacent node. In this example, the fallout visualization selector 316 is in an “off” position and accordingly fallout is not displayed.

The smart insight 318 represents an observation and/or analysis of the journey dataset 132 based on the visualization 118. In one example, the visualization module 116 leverages one or more AI-models to generate the smart insight 318 based on one or more properties of the journey dataset 132, previous user behaviors, and/or a structure of the visualization 118. In this example, the smart insight 318 indicates a highest conversion rate for the paths depicted by the visualization 118.

In the illustrated example, the visualization 118 includes a first node 320, a second node 322, a third node 324, and a fourth node 326 connected by various edges 130. Each node 128 represents an attribute of an entity journey. For instance, the first node 320 represents a touchpoint associated with a home page, the second node 322 represents a touchpoint associated with a particular Step 1 taken by a user, the third node 324 represents a touchpoint associated with a particular Step 2 taken by a user, and the fourth node 326 represents a metric 206 of a number of orders placed.

Each node 128 further includes a representation of the primary metric 136 (e.g., a number of users) as well as a percent of total of the primary metric 136, e.g., a percentage of a number of users. For instance, the first node 320 indicates that 35% of users (e.g., 1,140,878 users) began a user journey at the home page. The second node 322 include a visual representation of a quantitative transition 210 from the first node 320 to the second node 322, e.g., that 5% of a total number of users (e.g., 153,663 users) progressed from the home page to Step 1. The third node 324 indicates that 4% (e.g., 128,475 users) of users progressed from the home page, to Step 1, to Step 2. The fourth node 326 indicates that 3% of users (e.g., 114,986 users) progressed from the home page, to Step 1, to Step 2, and ultimately placed an order.

In various examples, the nodes 128 and/or the edges 130 are selectable, such as to perform a variety of functionality. In various examples, a particular node 128 is selectable to provide options such as to delete the particular node 128, duplicate the particular node 128, create a “filter” from the particular node 128, create an audience from the particular node 128, generate a breakdown of the particular node 128, display a trend associated with the particular node 128, display subsequent nodes after the particular node 128, provide directed analysis of the particular node 128, etc. A particular edge 130 is further selectable to provide options such as to add a label, delete the particular edge 130, create a “filter” from the particular edge 130, create an audience from the particular edge 130, provide directed analysis of the particular edge 130, etc.

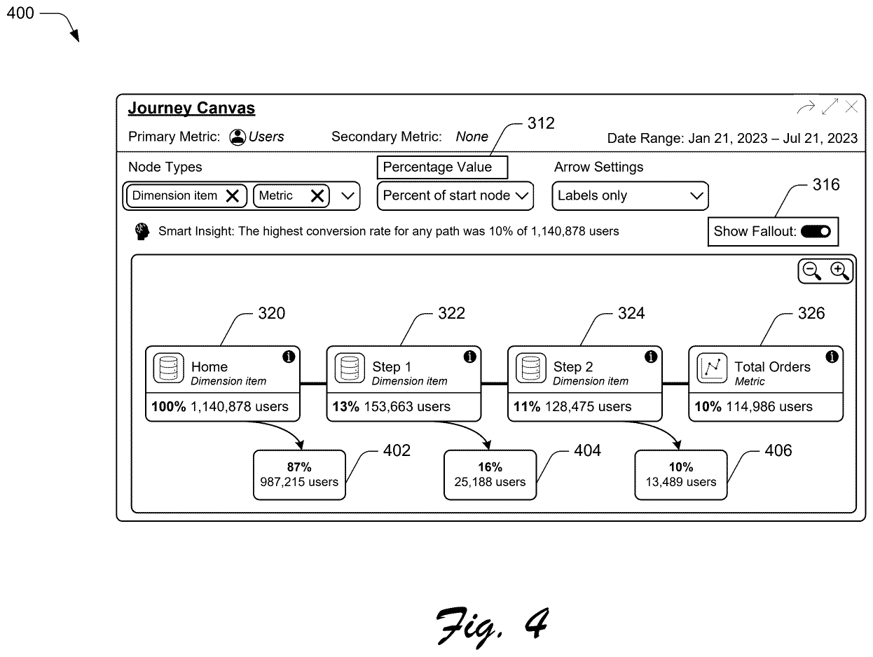

FIG. 4 depicts an example 400 of generation of an interactive visualization in which a fallout between nodes is depicted. The example 400, for instance, is a continuation of the example described above with respect to FIG. 3. In this example, the fallout visualization selector 316 is in an “on” position. Accordingly, the visualization 118 is updated in real time in accordance with the techniques described above to include visual representations of fallout between adjacent nodes.

For instance, in the illustrated example the visualization 118 includes a first fallout indication 402, a second fallout indication 404, and a third fallout indication 406. The first fallout indication 402 indicates a percentage and a number of users that “dropped-off” between the first node 320 and the second node 322. For instance, 87% of users did not progress to Step 1 after visiting the home page.

The second fallout indication 404 depicts a percentage and a number of users that that exited the entity journey between the second node 322 and the third node 324, e.g., 16% of users that went from the home page to Step 1 did not progress to Step 2. Similarly, the third fallout indication 406 indicates that 10% of users that made it to Step 2 in the entity journey did not provide an order. Accordingly, such visualizations depict a variety of insights based on dynamic journey data 122, e.g., in real time, which is not possible using conventional techniques.

Further, in this example the percentage value setting 312 is changed to display a “percent of start node” rather than a “percent of total.” Accordingly, the visualization module 116 updates the percentages depicted by each node 128 to represent a percent of the start node, e.g., the first node 320, in substantially real time. For instance, a percentage included at the first node 320 is 100%, a percentage included at the second node 322 is 13%, a percentage included at the third node 324 is 11%, and a percentage included at the fourth node 326 is 10%.

Although not depicted in the illustrated example, in various embodiments the techniques described herein are usable to allocate computational resources. For instance, the visualization module 116 is configured to identify fallout related to one or more attributes related to computational resource consumption, e.g., user fallout between adjacent nodes due to use of devices with insufficient processing power. In this way, the visualization module 116 is operable to efficiently identify steps of an entity journey that include relatively high computational demands. In various embodiments, the visualization module 116 is configured to deploy resources and/or implement mitigation strategies to reduce computational demands at the identified steps.

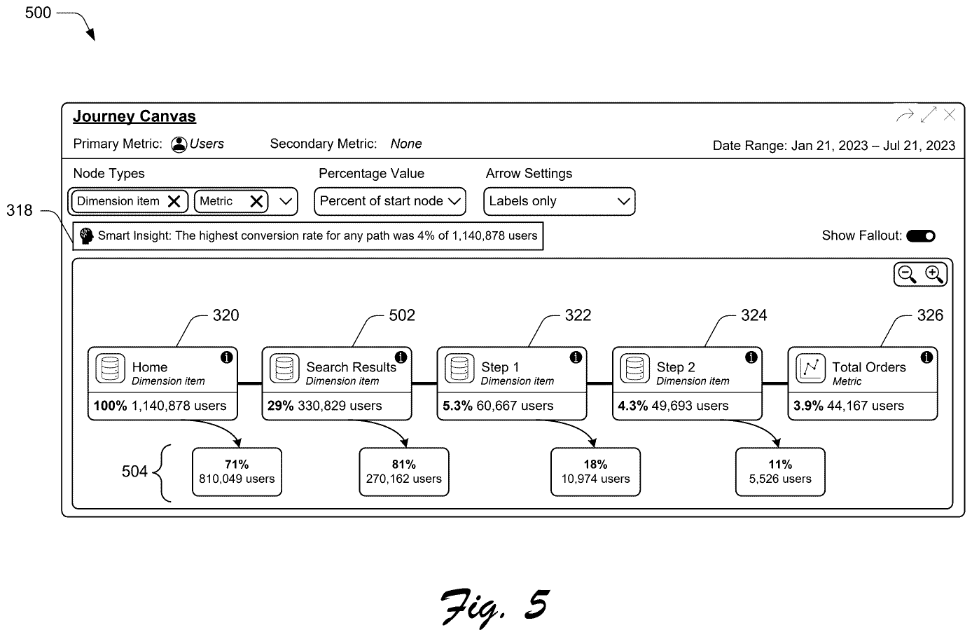

FIG. 5 depicts an example 500 of generation of an interactive visualization in which a node is added to the interactive visualization. The example 500, for instance, is a continuation of the example described above with respect to FIGS. 3 and 4. In this example, a fifth node 502 that represents a “Search Results” dimension 204 has been added to the visualization 118 between the first node 320 and the second node 322.

For instance, a user desires to view a step of an entity journey between the first node 320 that represents the home page and the second node 322 that represents Step 1. Accordingly, the visualization module 116 receives an interaction 126 to adjust a dimension 204 of the visualization 118. The interaction 126, for instance, includes a user input to add the fifth node 502 to the visualization 118. The fifth node 502 includes the dimension 204 that represents an action to access search results, such as after visiting the home page and before performance of Step 1.

In accordance with the techniques described above, the visualization module 116 updates the visualization 118 in real time such as through generation of one or more dataset queries 212 based on the interaction 126 and a structure of the visualization 118, e.g., based on the added dimension 204. For example, the visualization module 116 generates a dataset query 212 to determine a number of users that progressed from the home page to the search results touchpoint. The visualization module 116 causes the fifth node 502 to depict a result of the dataset query 212, e.g., a quantitative transition 210 of a number of users between the first node 320 and the fifth node 502.

The visualization module 116 further generates dataset queries 212 to update additional portions of the visualization 118, such as to update the second node 322, the third node 324, the fourth node 326, and various fallout indications 504, such as with updated quantitative transitions 210. Further, the visualization module 116 further updates the smart insight 318 in real time based on the interaction 126 and the change to the structure of the visualization 118. For instance, the smart insight 318 is automatically updated to indicate a path of the entity journey with a highest conversion rate.

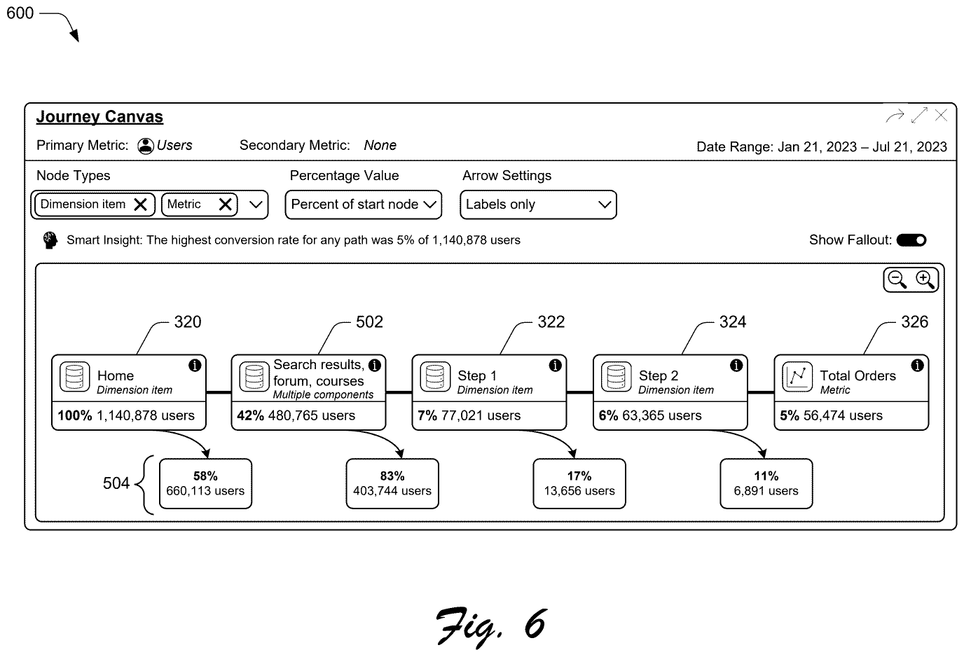

FIG. 6 depicts an example 600 of generation of an interactive visualization in which multiple dimensions are combined in an existing node of the interactive visualization. The example 600, for instance, is a continuation of the example described above with respect to FIGS. 3-5. In this example, two additional dimensions 204 are adjusted, e.g., added, to the fifth node 502.

For instance, a user desires to view users that progressed from the home page to either a search results touchpoint, a forum touchpoint, or a courses touchpoint. Accordingly, the visualization module 116 receives an interaction 126 to adjust one or more dimensions 204 of the visualization 118. For instance, the interaction 126 includes a user input to add a dimension 204 that represents a “forum” touchpoint and a dimension 204 that represents a “courses” touchpoint to the fifth node 502.

In accordance with the techniques described above, the visualization module 116 updates the visualization 118 based on the added dimensions 204. For instance, the visualization module 116 generates various dataset queries 212 to update the quantitative transitions 210 depicted by the fifth node 502, the second node 322, the third node 324, the fourth node 326, as well as the fallout indications 504.

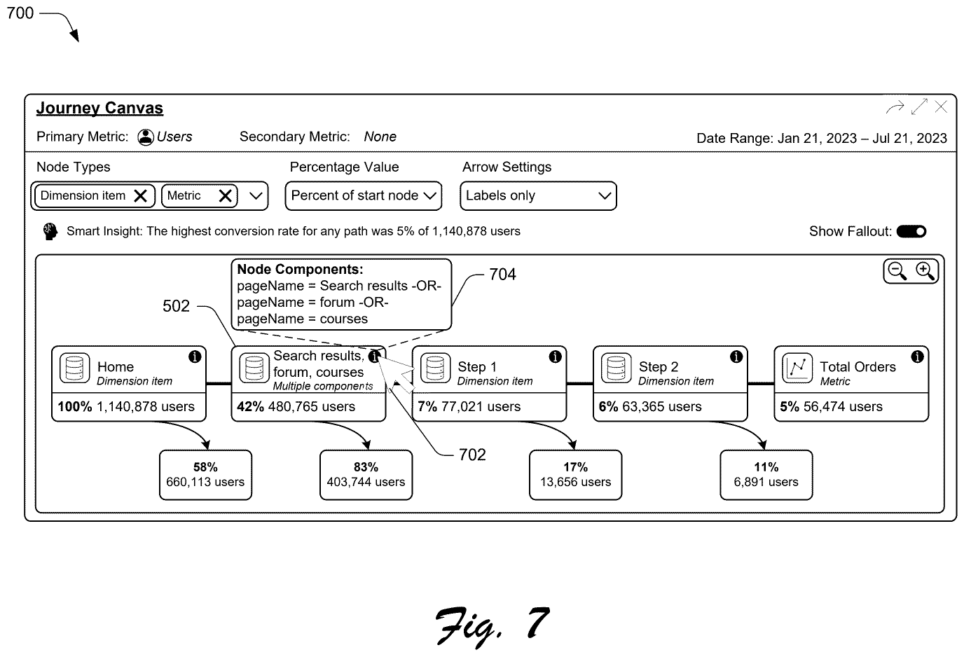

FIG. 7 depicts an example 700 of generation of an interactive visualization in which information about a particular node is displayed. The example 700, for instance, is a continuation of the example described above with respect to FIGS. 3-6. In this example, a user input 702 is provided to the interactive canvas 302 to view additional information about the fifth node 502.

For instance, the user input 702 includes an action to select an information icon included in the fifth node 502. The visualization module 116 causes a graphic 704 to be displayed by the visualization 118 that includes node components of the fifth node 502. In this example, the graphic 704 indicates that the fifth node 502 represents users that progressed from the home page to either a search results touchpoint, a forum touchpoint, or a courses touchpoint.

While in the illustrated example addition of a dimension 204 to a node 128 causes the node 128 to represent users that qualify for one or more of the dimensions 204 of the node, in some examples addition of a dimension 204 to a node 128 causes the node 128 to represent users that qualify for each of the dimensions 204 of the node. For instance, in an alternative example the fifth node 502 is configurable to represent users that progressed from the home page to a search results touchpoint, a forum touchpoint, and a courses touchpoint before progressing to Step 1. Thus, the visualization 118 is customizable to display a variety of properties of an entity journey.

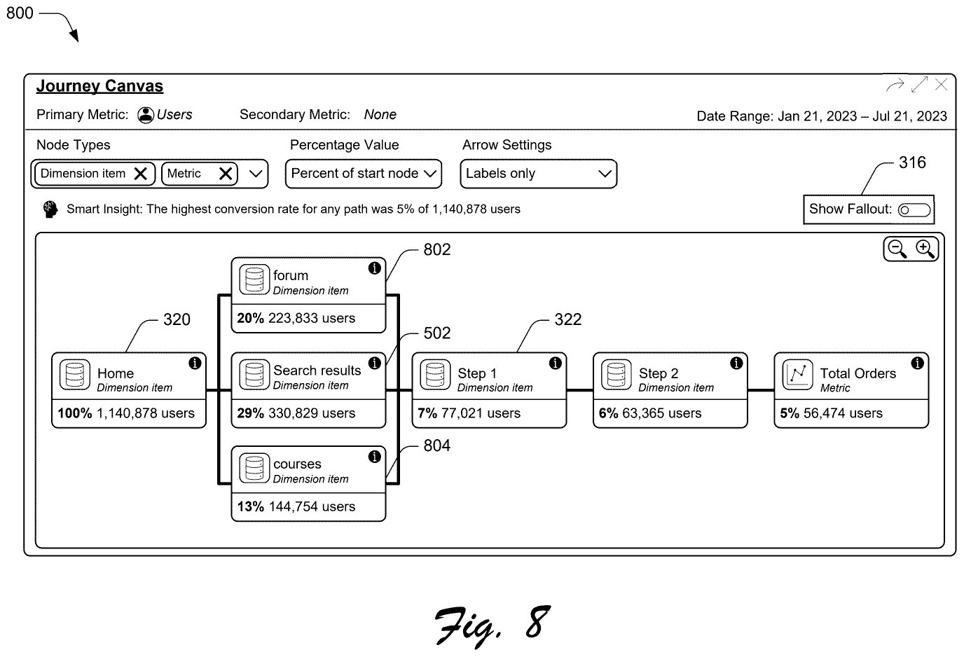

FIG. 8 depicts an example 800 of generation of an interactive visualization in which multiple nodes are added to the interactive visualization. The example 800, for instance, is a continuation of the example described above with respect to FIGS. 3-7. In this example the fallout visualization selector 316 is in an “off” position and accordingly fallout is not displayed. Further, a sixth node 802 has been added to the visualization 118 to represent the forum dimension and a seventh node 804 has been added to the visualization 118 to represent the courses dimension.

For instance, a user desires to individually view the steps of the entity journey that relate to the forum, search results, and courses touchpoints. Accordingly, the visualization module 116 receives an interaction 126 to add the sixth node 802 that represents a forum dimension and the seventh node 804 that represents a courses dimension. The fifth node 502 is updated to represent just the search results dimension. In accordance with the techniques described herein, the visualization module 116 updates the visualization 118 based on the structure of the visualization 118.

Further, the sixth node 802, fifth node 502, and seventh node 804 are added to the visualization 118 in a nonlinear manner, such as with outgoing branching edges 130 from the first node 320 and converging incoming edges to the second node 322. This overcomes limitations of conventional techniques that cannot accurately represent nonlinear entity journeys.

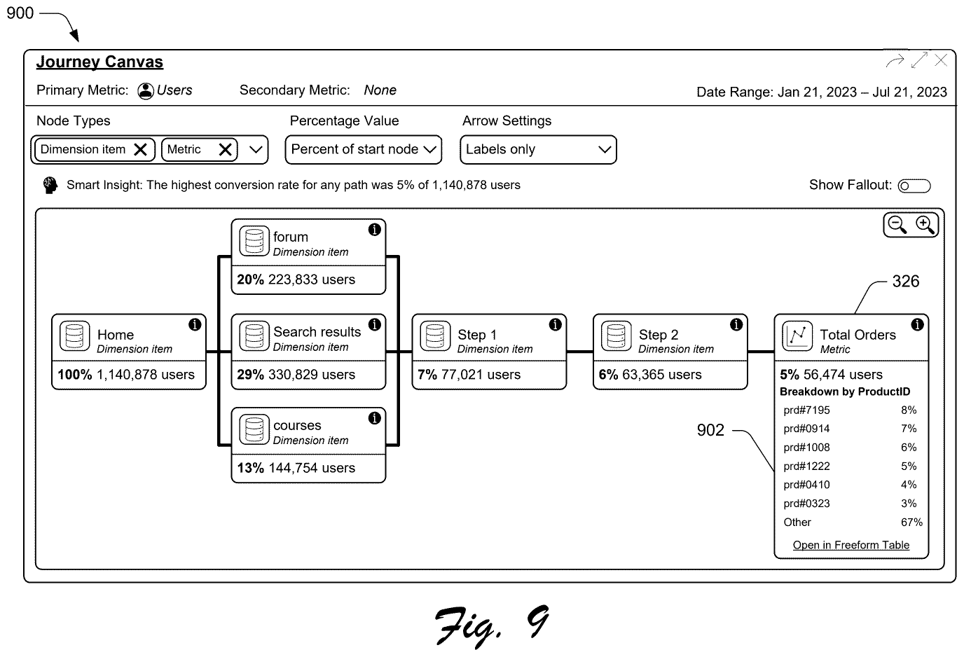

FIG. 9 depicts an example 900 of generation of an interactive visualization in which a dimension is added to an existing node of the interactive visualization to generate a node breakdown. The example 900, for instance, is a continuation of the example described above with respect to FIGS. 3-8. In this example, a dimension 204 that represents a “Product ID” is added to the fourth node 326.

For instance, a user desires to view which products were ordered by users that completed the entity journey. Accordingly, the visualization module 116 receives an interaction 126 such as a user input to add the ProductID dimension to the fourth node 326. Responsive to the input, the visualization module 116 generates a node breakdown 902 that depicts top elements (e.g., the top six elements) for the Product ID dimension with respect to the primary metric 136. The visualization module 116 is further configured to update the node breakdown 902 based on subsequent changes to the visualization 118 in real time in accordance with the techniques described herein.

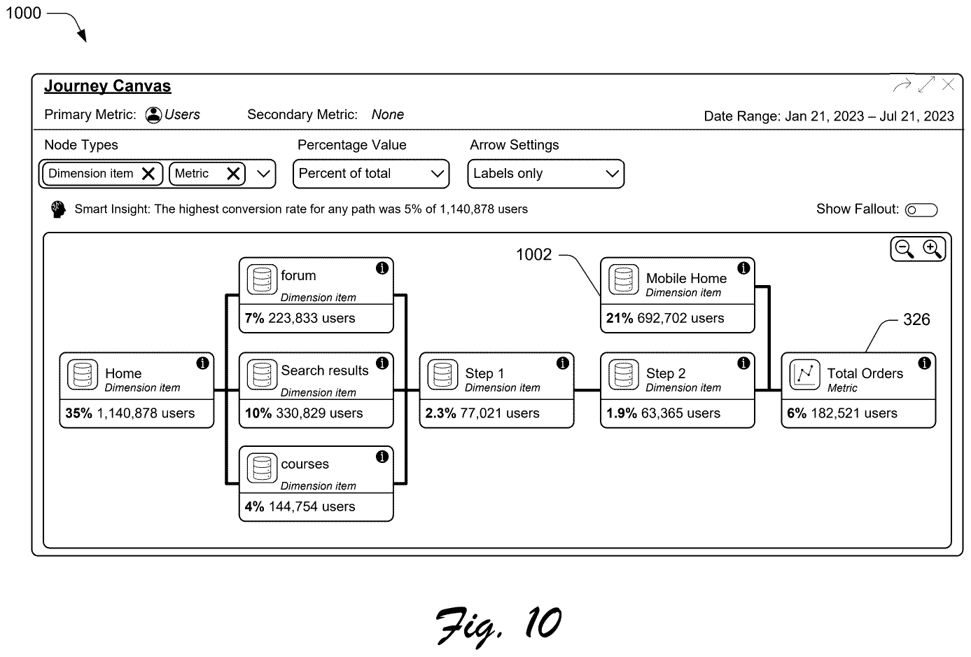

FIG. 10 depicts an example 1000 of generation of an interactive visualization in which a node is added to the interactive visualization. The example 1000, for instance, is a continuation of the example described above with respect to FIGS. 3-9. In this example, the node breakdown 902 has been removed from the visualization 118, however, an eighth node 1002 has been added to represent a dimension 204 for mobile orders.

Accordingly, the visualization module 116 updates the visualization 118 in accordance with the techniques described herein. For instance, the visualization module 116 updates the total orders depicted by the fourth node 326 to include orders that originated from a mobile home page. This is not possible using conventional techniques that use destructive data analysis techniques and/or are unable to represent and analyze dynamic cross-channel data in real time.

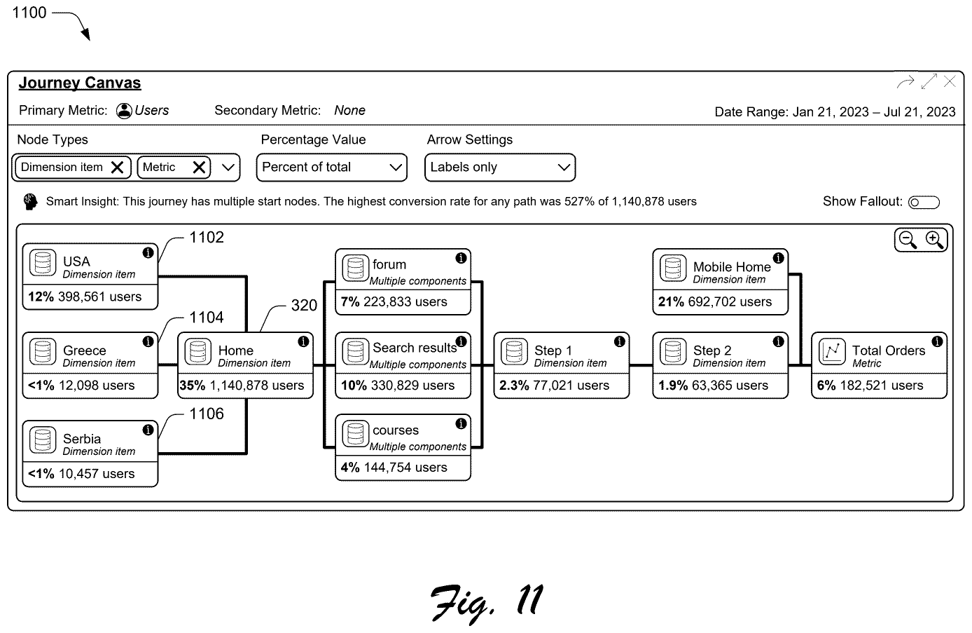

FIG. 11 depicts an example 1100 of generation of an interactive visualization in which a dimension is added to the interactive canvas. The example 1100, for instance, is a continuation of the example described above with respect to FIGS. 3-10. In this example, a dimension 204 that represents countries of users is added directly to the visualization 118 before the first node 320.

For instance, the visualization module 116 receives an interaction 126 to add a countries dimension to the visualization 118, e.g., a user input to “drag and drop” the countries dimension onto the interactive canvas 302. The visualization module 116 is operable to automatically generate a top “X” number of nodes 128 for that dimension 204, such as with respect to the primary metric 136. For instance, the visualization module 116 generates nodes 128 for the top three countries in terms of a number of users to participate in the entity journey.

As illustrated, the visualization module 116 automatically generates a ninth node 1102, a tenth node 1104, and an eleventh node 1106 for inclusion in the visualization 118. The ninth node 1102, tenth node 1104, and eleventh node 1106 are connected to the first node 320 by edges 130, and the visualization module 116 updates metrics displayed by the ninth node 1102, tenth node 1104, and eleventh node 1106 accordingly. For instance, the ninth node 1102 indicates that 12% of users to visit the home page were from the United States, the tenth node 1104 indicates that <1% of users were from Greece, and the eleventh node 1106 indicates that <1% of users were from Serbia. This functionality, such as adding a dimension 204 to a visualization 118 to automatically generate one or more nodes 128, is not possible using conventional techniques that implement destructive data analysis techniques and/or are reliant on static models.

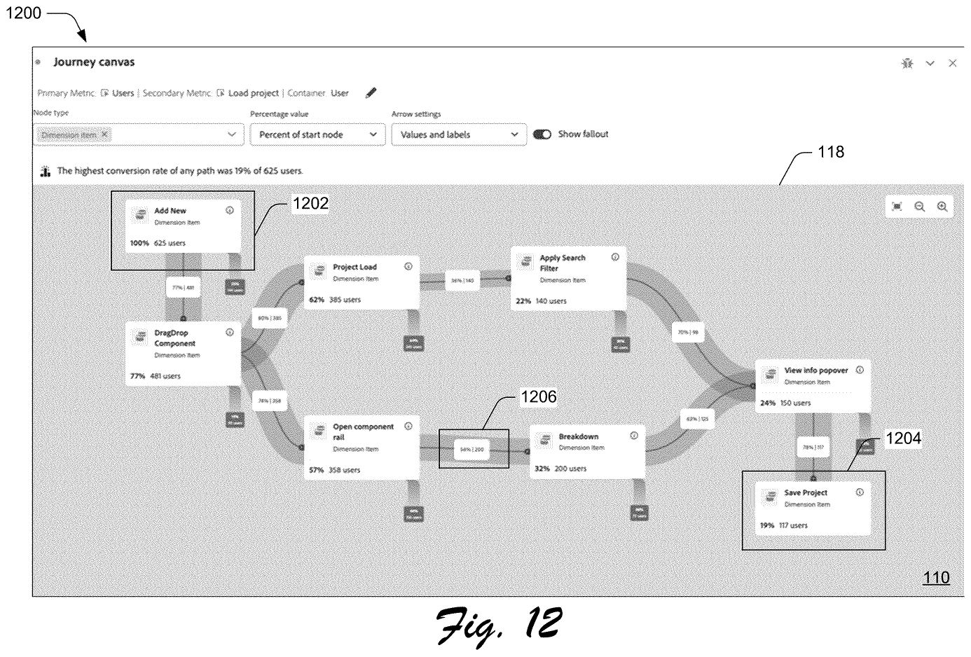

FIG. 12 depicts an example 1200 of an interactive visualization of an entity journey. In this example, a user interface displays a visualization 118 that represents a user journey within an application from a start node 1202 that represents a user action to add a new component to a terminal node 1204 that represents a user action to save a project. The visualization 118 includes a variety of intermediate nodes between the start node 1202 and the terminal node 1204 that represent various user actions, such as to drag and drop a component, open a component rail, perform a project load operation, etc. Each node 128 in this example further provides an indication of fallout between adjacent nodes 128.

In this example, the edges 130 includes various visual indicia, such as metrics 206 indicating a quantitative transition 210 between adjacent nodes. For instance, an edge label 1206 indicates that 56% of users that performed an “open component rail” action proceeded to perform a “breakdown” action. Accordingly, the techniques described herein provide dynamic visual representations of a user journey within an application, and thus inform a variety of actions. For instance, the visualization 118 indicates which steps of the application user journey have relatively high use, are redundant, result in fallout, etc. In various embodiments, the visualization module 116 is configured to perform one or more actions based on the visualization 118, such as to modify properties of the application based on the visualization 118.

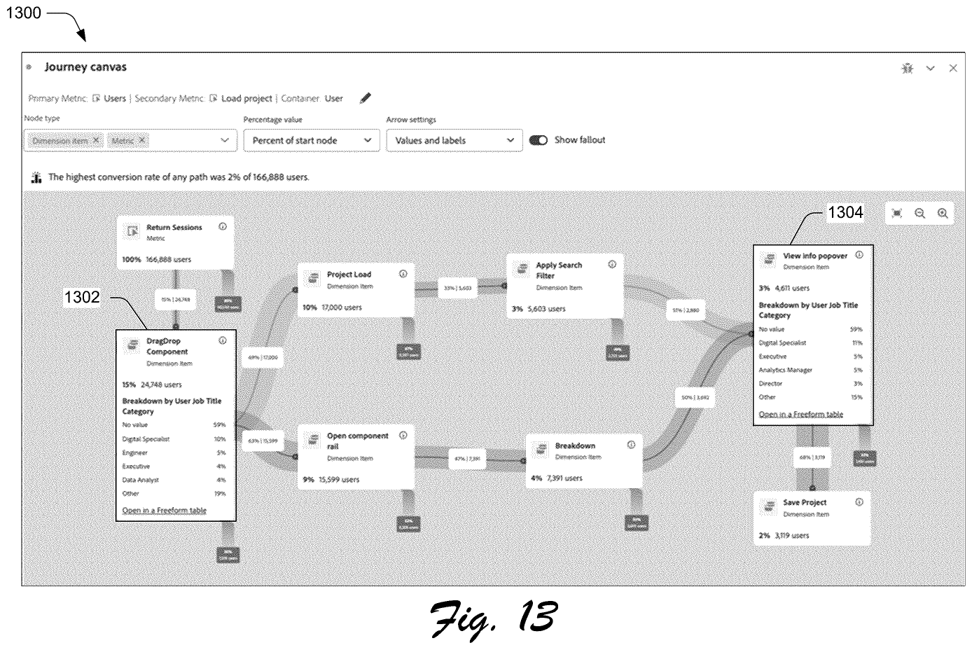

FIG. 13 depicts an example 1300 of generation of an interactive visualization in which a dimension is added to a node to generate a node breakdown. Similar to the example discussed above with respect to FIG. 9, in this example an interaction 126 is received to adjust a dimension 204 of the visualization 118, such as to add a dimension 204 to nodes 128 of the visualization 118.

The visualization 118 in this example represents a user journey within a particular application, and each node 128 represents an action and/or metric 206 related to the application user journey. In this example, the interaction 126 includes an action to add a “job title” dimension 204 to a node that represents an action to drag and drop a component. The interaction 126 further includes an action to add the job title dimension 204 to a node that represents an action to view info popover.

Responsive to the interaction 126, the visualization module 116 generates a first breakdown 1302 and a second breakdown 1304. The first breakdown 1302 includes elements of the job title dimension 204 at the “drag and drop component” node that have a value of the primary metric 136 above a threshold, e.g., the top five job titles. For instance, the first breakdown 1302 indicates that of the users that qualify for the drag and drop component node, 59% do not have an associated job title, 10% are digital specialists, 5% are engineers, 4% are executives, 4% are data scientists, and 19% have other job titles.

Similarly, the second breakdown 1304 includes top five elements for the job title dimension 204 at the “view info popover” node. For instance, the second breakdown 1304 indicates that of the users that qualify for the view info popover node, 59% do not have an associated job title, 11% are digital specialists, 5% are executives, 5% are analytics managers, 3% are directors, and 15% have other job titles. The visualization module 116 is further operable to update the first breakdown 1302 and the second breakdown 1304 in real time in accordance with the techniques described above (e.g., via one or more dataset queries 212 to the journey dataset 132) such as based on updated journey data 122 and/or on various changes to the visualization 118 which is not possible using conventional techniques.

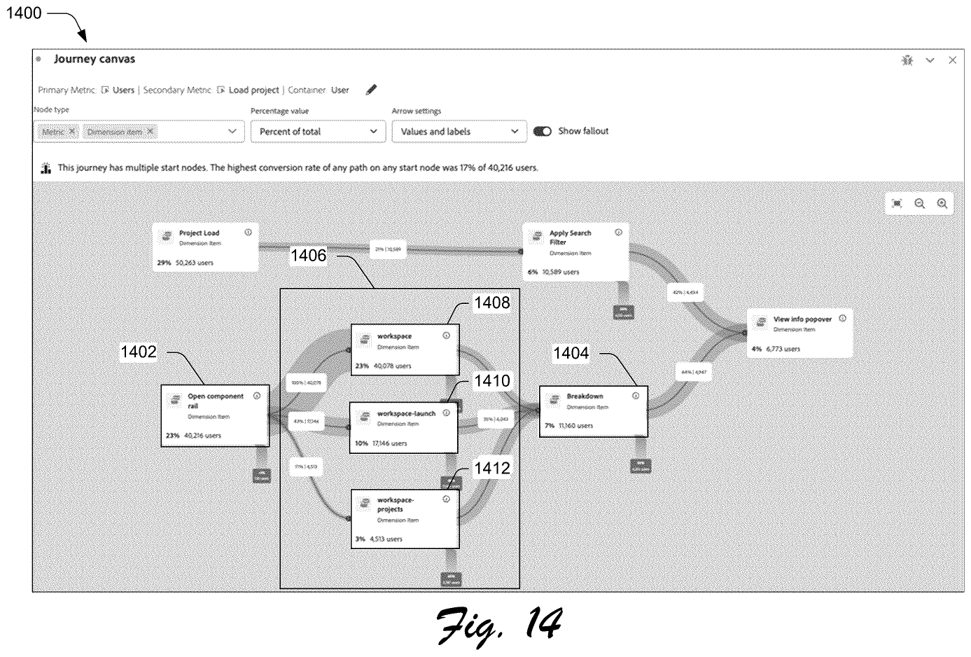

FIG. 14 depicts an example 1400 of generation of an interactive visualization in which a dimension is added to an edge between adjacent nodes. In this example, a user desires to view “what happened” between a first node 1402 that represents an “open component rail” action and a second node 1404 that represents a “breakdown” action. For instance, the user desires to view which elements of the dimension 204 were “most popular” directly after the first node 1402 and before the second node 1404.

Accordingly, the user adds a dimension 204 (e.g., a dimension 204 that pertains to a workspace feature) to an edge 130 between the first node 1402 and the second node 1404. Individual elements within the workspace operation dimension, for instance, represent different touchpoints within the dimension 204. Responsive to receipt of the interaction 126 to add the dimension 204 to the edge 130, the visualization module 116 generates an interstitial graphic 1406 that includes new nodes 128 for each element within the dimension 204 that is associated with a value of the primary metric 136 that is above a threshold. The visualization module 116 generates information to be represented by the interstitial graphic 1406 in accordance with the techniques described herein, such as via generation of one or more dataset queries 212 to the journey dataset 132.

As illustrated, the interstitial graphic 1406 includes a third node 1408, a fourth node 1410, and a third node 1412 that represent a “top three” elements of the dimension 204 with respect to the primary metric 136. For instance, the third node 1408 represents a relatively most frequented touchpoint within the workspace feature dimension directly after the first node 1402, e.g., after the open component rail action and before the breakdown action. As illustrated, the third node 1408 indicates that 23% of users on the path from the first node 1402 to the second node 1404 engaged with a “workspace” touchpoint.

The fourth node 1410 represents a second most frequented touchpoint within the workspace feature dimension. For instance, the fourth node 1410 indicates that 10% of users on the path from the first node 1402 to the second node 1404 engaged with a “workspace-launch” touchpoint. The third node 1412 represents a third most frequented touchpoint within the workspace feature dimension and indicates that 3% of users on the path from the first node 1402 to the second node 1404 engaged with a “workspace-operation” touchpoint. In this way, the techniques described herein are usable to provide in depth analyses of entity behaviors between adjacent nodes 128 in real time, which is not possible using conventional techniques that lack an ability to process dynamic journey data 122 and generate granular insights.

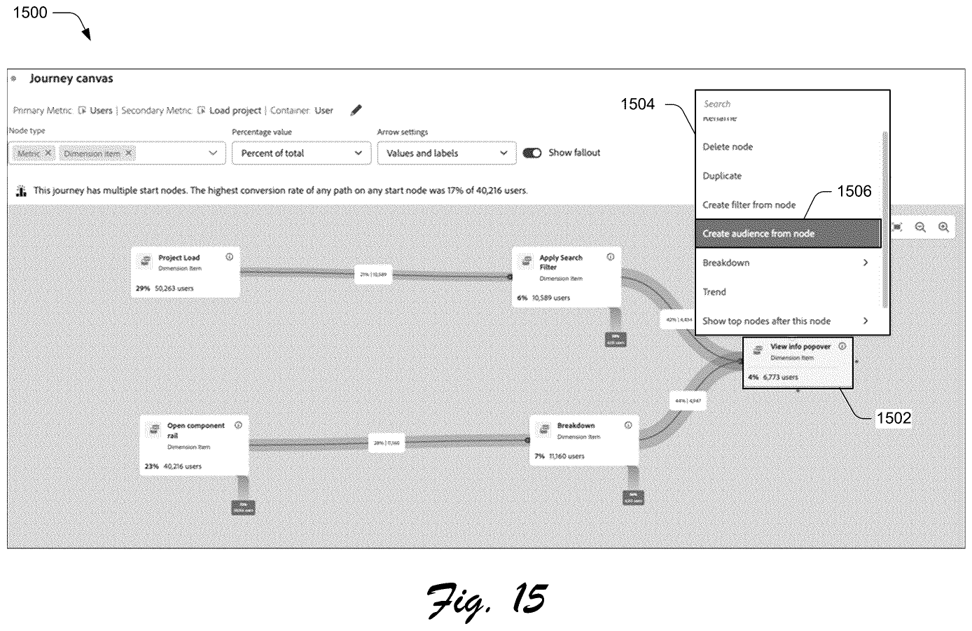

FIG. 15 depicts an example 1500 of generation of an interactive visualization in which an audience segment is generated from a particular node. In this example, the visualization module 116 receives an input to select a node 1502. Responsive to the input, the visualization module 116 causes a menu 1504 that includes various selectable options to be displayed. The visualization module 116 further receives an input to select an option 1506 to create an audience, e.g., an entity segment 220, from the node 1502.

Responsive to the input, the 116 leverages the segment module 218 to generate the entity segment 220. In this example, the entity segment 220 includes representations of users that qualify for the node 1502. For instance, the entity segment 220 includes a list of user ID's for the 4% (e.g., 6773 users) that have progressed through the user journey to perform a “view info popover” action. The segment module 218 is further operable to perform an action with respect to the entity segment 220, such as to transmit a digital communication to the entity segment 220. For instance, the segment module 218 communicates instructions for “what to do next” after the “view info popover” action. Accordingly, the techniques described herein provide for a variety of functionality not possible using conventional user journey analytics.

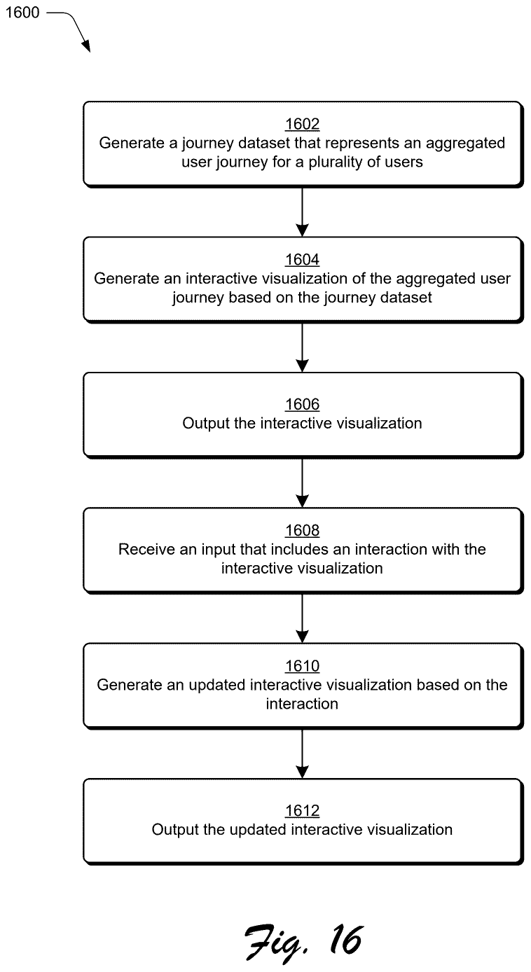

FIG. 16 is a flow diagram depicting an algorithm as a step-by-step procedure 1600 in an example implementation that is performable by a processing device to generate and transform an interactive visualization of an aggregated user journey.

To being in this example, a journey dataset is generated (block 1602). The journey dataset 132, for instance, represents an aggregated user journey for a plurality of users and is generated based on a variety of journey data 122. The visualization module 116 is configured to construct the journey dataset 132 to include one or more dimensions 204 that represent categorical attributes of the journey data 122 as well as one or more metrics 206 that represent one or more quantitative attributes of the journey data 122. In at least one example, the visualization module 116 leverages a query engine 134, e.g., an optimized columnar database query engine, to generate, maintain, and/or analyze the journey data 122 and/or the journey dataset 132. In various implementations, the journey dataset 132 represents attributes of the journey data 122 using a binary bit shifted format.

An interactive visualization of the aggregated journey is then generated based on the journey dataset (block 1604). The visualization 118, for instance, includes one or more nodes 128 connected by one or more edges 130. In various embodiments, the visualization 118 further includes a variety of visual indicia such as a representation of a quantitative transition 210 of a primary metric 136 between adjacent nodes 128. In at least one example, the visualization 118 has a nonlinear and directed acyclic structure.

The visualization module 116 generates the visualization 118 based on the journey data 122 as well as on a construction input 124. The construction input 124, for instance, defines a structure of the visualization 118, such as an initial configuration of nodes 128, edges 130, and/or various parameters to construct the visualization 118. In an example, the construction input 124 includes a user input to position various nodes 128 and/or edges 130 on a digital canvas.

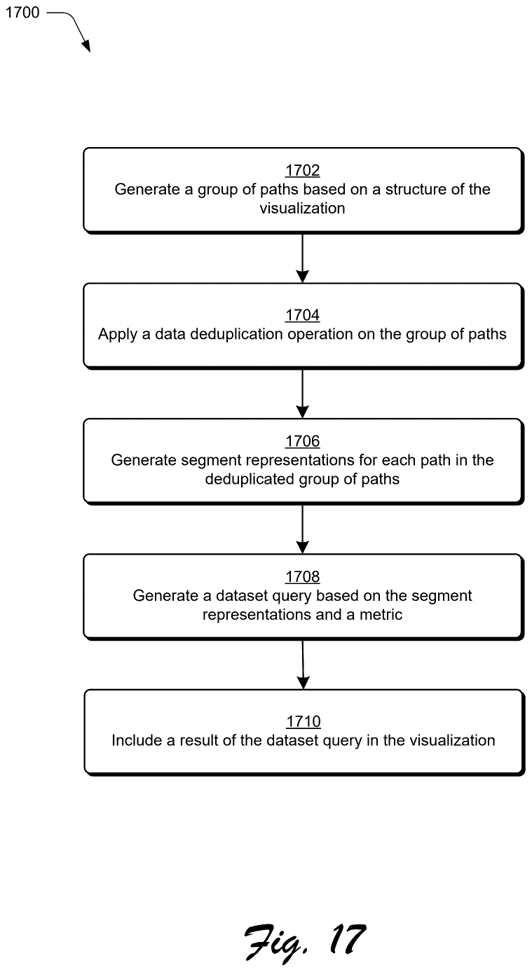

As further described below with respect to FIG. 17, in various embodiments, the visualization module 116 leverages a query engine 134 to populate and update information to the visualization 118. For instance, the visualization module 116 generates a dataset query 212 based on a structure of the visualization 118 that includes a structured request for particular data and/or analysis of the journey data 122. The visualization module 116 leverages the query engine 134 to generate a response to the dataset query 212 and populates the response to corresponding visual indicia of the visualization 118, such as to generate the quantitative transition 210.

The interactive visualization is then output (block 1606). For instance, the visualization module 116 causes the visualization 118 to be displayed, such as in a user interface 110 of a display device 112. The user interface 110 in various examples further includes a variety of selectable indicia to control various aspects of the visualization 118.

An input is then received that includes an interaction with the interactive visualization (block 1608). The interaction 126, for instance, represents an input to change one or more properties of the visualization 118 such as to apply one or more transformations to the visualization 118. A variety of interactions 126 are considered, such as to add/remove/reposition one or more of the nodes 128 and/or edges 130, generate various supplemental analyses, and/or perform a variety of functionality.

In some examples, the transformation includes adjusting a dimension 204 of the visualization 118. Adjusting the dimension 204, for instance, includes one or more of adding the dimension 204 to the visualization 118 (such as to a node 128 and/or an edge 130), removing the dimension 204, combining the dimension 204 with an additional dimension, etc.

An updated interactive visualization is generated based on the interaction (block 1610). For instance, the visualization module 116 updates various visual indicia impacted by the interaction 126. As further described below with respect to FIG. 17, in various embodiments, the visualization module 116 leverages the query engine 134 to populate and update information to the visualization 118.

For instance, the visualization module 116 generates an additional dataset query 212 based on an updated structure of the visualization 118 and the interaction 126. The query engine 134 queries the journey dataset 132 to generate a response to the additional dataset query 212 and the visualization module 116 populates the response to corresponding visual indicia of the visualization 118, such as to update the quantitative transition 210.

The updated interactive visualization is then output (block 1612). For instance, the visualization module 116 causes the updated visualization 216 to be displayed, such as in a user interface 110 of a display device 112. In an example, the updated visualization 216 has the transformation specified by the interaction 126 applied and depicts updated visual indicia.

FIG. 17 is a flow diagram depicting an algorithm as a step-by-step procedure 1700 in an example implementation that is performable by a processing device to generate a dataset query to obtain information for inclusion in an interactive visualization. One or more steps and/or blocks of the procedure 1700, for instance, are implementable as one or more substeps of block 1604 and/or 1610 of the procedure 1600.

To begin in this example, a group of paths is generated based on a structure of the visualization (block 1702). The group of paths, for instance, includes one or more paths for each node 128 and/or each edge 130 of the visualization 118 and/or the updated visualization 216. A path, for instance, is representative of a potential action and/or sequence of actions taken by an entity as part of an entity journey.

A data deduplication operation is performed on the group of paths (block 1704). For instance, the rendering module 208 identifies and eliminates redundant paths included in the group of paths, such as to conserve computational resources during processing of the one or more dataset queries 212.

Segment representations are then generated for each path in the deduplicated group of paths (block 1706). A segment representation, for instance, includes one or more entities included in the journey dataset 132 that qualify for a particular path. An entity qualifies for a particular path if the entity has traversed the nodes 128 and edges 130 of the particular path in an order prescribed by the path.

A dataset query is then generated based on the segment representations and a metric (block 1708). The dataset query 212, for instance, is a structured request for information from the journey dataset 132 and includes a particular metric 206, e.g., the primary metric 136, and one or more of the segment representations. For example, a particular dataset query 212 includes a particular segment representation, the primary metric 136, and a request for information from the journey dataset 132. In various examples, a dataset query 212 further includes a representation of and/or is based on an interaction 126.

A result of the dataset query is then included in the visualization (1710). For instance, the visualization module 116 leverages the query engine 134 to process the dataset query 212 to generate a result. The visualization module 116 populates the result to corresponding visual indicia of the visualization 118 and/or the updated visualization 216. In this way, the techniques described herein implement retroactive analysis to preserve underlying data of the journey dataset 132 to support a variety of real time modification.

### Example System and Device

FIG. 18 illustrates an example system generally at 1800 that includes an example computing device 1802 that is representative of one or more computing systems and/or devices that implement the various techniques described herein. This is illustrated through inclusion of the visualization module 116. The computing device 1802 is configurable, for example, as a server of a service provider, a device associated with a client (e.g., a client device), an on-chip system, and/or any other suitable computing device or computing system.

The example computing device 1802 as illustrated includes a processing system 1804, one or more computer-readable media 1806, and one or more I/O interface 1808 that are communicatively coupled, one to another. Although not shown, the computing device 1802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1804 is representative of functionality to perform one or more operations using hardware. Accordingly, the processing system 1804 is illustrated as including hardware element 1810 that is configurable as processors, functional blocks, and so forth. This includes implementation in hardware as an application specific integrated circuit or other logic device formed using one or more semiconductors. The hardware elements 1810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1806 is illustrated as including memory/storage 1812. The memory/storage 1812 represents memory/storage capacity associated with one or more computer-readable media. The memory/storage 1812 includes volatile media (such as random access memory (RAM)) and/or nonvolatile media (such as read only memory (ROM), Flash memory, optical disks, magnetic disks, and so forth). The memory/storage 1812 includes fixed media (e.g., RAM, ROM, a fixed hard drive, and so on) as well as removable media (e.g., Flash memory, a removable hard drive, an optical disc, and so forth). The computer-readable media 1806 is configurable in a variety of other ways as further described below.

Input/output interface(s) 1808 are representative of functionality to allow a user to enter commands and information to computing device 1802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1810 and computer-readable media 1806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 1810. The computing device 1802 is configured to implement particular instructions and/or functions corresponding to the software and/or hardware modules. Accordingly, implementation of a module that is executable by the computing device 1802 as software is achieved at least partially in hardware, e.g., through use of computer-readable storage media and/or hardware elements 1810 of the processing system 1804. The instructions and/or functions are executable/operable by one or more articles of manufacture (for example, one or more computing devices 1802 and/or processing systems 1804) to implement techniques, modules, and examples described herein.

The techniques described herein are supported by various configurations of the computing device 1802 and are not limited to the specific examples of the techniques described herein. This functionality is also implementable all or in part through use of a distributed system, such as over a “cloud” 1814 via a platform 1816 as described below.

The cloud 1814 includes and/or is representative of a platform 1816 for resources 1818. The platform 1816 abstracts underlying functionality of hardware (e.g., servers) and software resources of the cloud 1814. The resources 1818 include applications and/or data that can be utilized while computer processing is executed on servers that are remote from the computing device 1802. Resources 1818 can also include services provided over the Internet and/or through a subscriber network, such as a cellular or Wi-Fi network.

The platform 1816 abstracts resources and functions to connect the computing device 1802 with other computing devices. The platform 1816 also serves to abstract scaling of resources to provide a corresponding level of scale to encountered demand for the resources 1818 that are implemented via the platform 1816. Accordingly, in an interconnected device embodiment, implementation of functionality described herein is distributable throughout the system 1800. For example, the functionality is implementable in part on the computing device 1802 as well as via the platform 1816 that abstracts the functionality of the cloud 1814.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
presenting, in a user interface of a processing device, an interactive visualization of an aggregated user journey for a plurality of users that includes a first node connected to a second node by an edge, the interactive visualization depicting a quantitative transition of a primary metric from the first node to the second node;
receiving, by the processing device, an input via the user interface to apply a transformation to the interactive visualization by adjusting a dimension that represents a categorical attribute of the aggregated user journey, the transformation applied to at least one of the first node, the second node, or the edge; and
generating, by the processing device, an updated interactive visualization for display by the processing device that includes an updated quantitative transition based on the adjusted dimension.

2. The method as described in claim 1, wherein the transformation includes adding the dimension to one or more of the first node or the second node, and the generating the updated interactive visualization includes generating a node breakdown to be included in one or more of the first node or the second node, the node breakdown including elements of the categorical attribute that have a value of the primary metric above a threshold.

3. The method as described in claim 1, wherein the transformation includes adding the dimension to the edge, and the generating the updated interactive visualization includes generating at least one additional node between the first node and the second node, the at least one additional node representing an element of the categorical attribute that has a value for the primary metric above a threshold.

4. The method as described in claim 1, wherein the interactive visualization further depicts a quantitative transition of at least one secondary metric from the first node to the second node.

5. The method as described in claim 1, wherein the generating the updated interactive visualization includes:
generating, based on a structure of the updated interactive visualization, one or more dataset queries for processing by a sharded query engine; and
processing the one or more dataset queries by the sharded query engine using non-destructive analysis to generate the updated quantitative transition.

6. The method as described in claim 5, wherein the generating the one or more dataset queries includes:
generating a group of paths that includes at least one path for each node and each edge of the updated interactive visualization;
creating a segment representation for each path in the group of paths that includes users of the plurality of users that qualify for the respective paths; and
generating the one or more dataset queries for each segment representation with respect to the primary metric.

7. The method as described in claim 6, wherein the generating the one or more dataset queries further includes performing a deduplication operation on the group of paths.

8. The method as described in claim 1, wherein the updated interactive visualization includes a nonlinear directed acyclic structure, at least one branched edge, and at least one converging edge.

9. A system comprising:
a memory component; and
a processing device coupled to the memory component, the processing device to perform operations including:
generating a journey dataset that represents an aggregated user journey for a plurality of users based on cross-channel journey data, the journey dataset generated to include one or more dimensions that represent categorical attributes of the journey dataset and one or more metrics that represent quantitative attributes of the journey dataset;
generating an interactive visualization of a user journey based on the journey dataset, the interactive visualization including:
a first node that represents a first attribute of the journey dataset;
a second node that represents a second attribute of the journey dataset, the second node connected to the first node by an edge; and
a visual representation of a quantitative transition of a primary metric from the first node to the second node; and
outputting the interactive visualization of the user journey in a user interface of the processing device.

10. The system as described in claim 9, wherein generating the journey dataset includes implementing a query engine configured for retroactive and non-destructive sharded processing operations to process the cross-channel journey data.

11. The system as described in claim 9, wherein the cross-channel journey data describes a cross-channel interaction between a digital touchpoint and a non-digital touchpoint.

12. The system as described in claim 9, wherein the interactive visualization further includes a visual representation of user fallout between adjacent nodes.

13. The system as described in claim 9, further comprising generating an audience segment that includes users of the plurality of users that qualify for one or more of the first node or the second node.

14. The system as described in claim 9, wherein generating the interactive visualization includes:
generating one or more dataset queries for processing by a sharded query engine; and
processing the one or more dataset queries by the sharded query engine using non-destructive analysis to generate the quantitative transition.

15. The system as described in claim 9, wherein the interactive visualization includes a nonlinear directed acyclic structure, at least one branched edge, and at least one converging edge.

16. The system as described in claim 9, wherein one or more of the dimensions or the metrics include an integrated data processing operation, the integrated data processing operation including one or more of a string manipulation operation, a value filtering operation, or an entity deduplication operation.

17. A non-transitory computer-readable storage medium storing executable instructions, which when executed by a processing device, cause the processing device to perform operations comprising:
presenting an interactive visualization of an aggregated entity journey for a plurality of entities in a user interface of the processing device, the interactive visualization depicting a quantitative transition of a primary metric between a first node that represents a first attribute of the aggregated entity journey and a second node that represents a second attribute of the aggregated entity journey, the first node connected to the second node by an edge;
receiving an interaction to the interactive visualization in the user interface to add a third attribute of the aggregated entity journey to the edge; and
updating, responsive to the interaction, the interactive visualization to include at least one additional node to the edge between the first node and the second node, the at least one additional node having a value of the primary metric for the third attribute above a threshold.

18. The non-transitory computer-readable storage medium as described in claim 17, wherein updating the interactive visualization includes generating a dataset query for processing by a sharded query engine, the dataset query including the third attribute and the primary metric.

19. The non-transitory computer-readable storage medium as described in claim 17, wherein updating the interactive visualization includes generating a quantitative transition between the first node and the at least one additional node and generating a quantitative transition between the at least one additional node and the second node for display by the interactive visualization.

20. The non-transitory computer-readable storage medium as described in claim 17, wherein the first attribute, the second attribute, and the third attribute are dimensions that represent categorical attributes of the aggregated entity journey and the primary metric represents a number of users.
